(19) United States
(12) Patent Application Publication
(10) Pub. No.: US 2012/0106662 A1
(43) Pub. Date: May 3, 2012

(54) WIRELESS COMMUNICATION APPARATUS, DECODING PROCESSING METHOD AND WIRELESS COMMUNICATION SYSTEM

(75) Inventor: Shunji MIYAZAKI, Kawasaki (JP)

(73) Assignee: FUJITSU LIMITED, Kawasaki-shi (JP)

(21) Appl. No.: 13/283,758

(22) Filed: Oct. 28, 2011

(30) Foreign Application Priority Data
Nov. 1, 2010 (JP) 2010-244924

(51) Int. Cl. H04L 27/06; H04L 27/00

(52) U.S. Cl. 375/259; 375/340

(57) ABSTRACT

A wireless communication apparatus includes a demodulator that demodulates data on which coding processing is performed for each first block unit and channel coding processing included in the coding processing is performed for each second block unit smaller than the first block unit by a transmission side wireless communication apparatus, and a decoder that performs decoding processing of the demodulated data for each unit of processing including at least one second block unit.

### CROSS-REFERENCE TO RELATED APPLICATION

This application is based upon and claims the benefit of priority of the prior Japanese Patent Application No. 2010-244924, filed on Nov. 1, 2010, the entire contents of which are incorporated herein by reference.

### FIELD

Embodiments described herein relate to a wireless communication apparatus and a wireless communication system that perform decoding processing and a decoding processing method.

### BACKGROUND

There is a wireless communication system in which a specified number of information bits are processed and transmitted/received at a time (for example, see 3rd Generation Partnership Project (3GPP) TS 25.212 v8.6.0). For example, a transmission side performs data transmission processing for each transport block (hereinafter referred to as TRB), and a reception side performs data reception processing for each TRB.

### SUMMARY

According to an aspect of the embodiments discussed herein, a wireless communication apparatus includes a demodulator that demodulates data on which coding processing is performed for each first block unit and channel coding processing included in the coding processing is performed for each second block unit smaller than the first block unit by a transmission side wireless communication apparatus, and a decoder that performs decoding processing of the demodulated data for each unit of processing including at least one second block unit.

Additional objects and advantages of the embodiments will be set forth in part in the description which follows, and in part will be obvious from the description, or may be learned by practice of the embodiments. The object and advantages of the embodiments will be realized and attained at least by the elements, features, and combinations particularly pointed out in the appended claims.

It is to be understood that both the foregoing summary description and the following detailed description are exemplary and explanatory and are not restrictive of the embodiments, as claimed.

### BRIEF DESCRIPTION OF DRAWINGS

FIG. 1 is a diagram illustrating a wireless communication apparatus according to a first embodiment.

FIG. 2 is a diagram illustrating an operation of the wireless communication apparatus.

FIG. 3 is a diagram illustrating hardware blocks of a wireless communication apparatus according to a second embodiment.

FIG. 4 is a diagram illustrating functional blocks of the wireless communication apparatus.

FIG. 5 is a flowchart of coding processing in a transmission side.

FIG. 6 is a diagram illustrating bit collection.

FIG. 7 is a diagram illustrating channel interleaving.

FIG. 8 is a flowchart of decoding processing of the wireless communication apparatus.

FIG. 9 is a diagram illustrating likelihood generation.

FIG. 10 is a diagram illustrating an example of data outputted from a likelihood generation section.

FIG. 11 is a diagram illustrating de-constellation rearrangement processing.

FIG. 12 is a diagram illustrating channel de-interleaving processing.

FIG. 13 is a diagram illustrating bit de-collection processing.

FIG. 14 is a diagram illustrating data on which the bit de-collection processing is performed.

FIG. 15 is a diagram illustrating variable definition for calculating a unit of CB.

FIG. 16 is a diagram illustrating an example of an algorithm for calculating a unit of CB.

FIG. 17 is a diagram illustrating an example of an algorithm for calculating a unit of CB.

FIG. 18 is a diagram illustrating second de-rate matching processing.

FIG. 19 is a diagram illustrating an example of an algorithm of de-puncture processing of the second de-rate matching processing.

FIG. 20 is a diagram illustrating an example of an algorithm of repetition processing of the second de-rate matching processing.

FIG. 21 is a diagram illustrating size calculation after first rate matching.

FIG. 22 is a diagram illustrating an example of an algorithm of the size calculation after the first rate matching.

FIG. 23 is a diagram illustrating functional blocks of a wireless communication apparatus according to a third embodiment.

FIG. 24 is a flowchart of decoding processing.

FIG. 25 is a diagram illustrating collective processing.

FIG. 26 is a diagram illustrating variable definition for the collective processing.

FIG. 27 is a diagram illustrating an example of an algorithm of the collective processing.

FIG. 28 is a diagram illustrating an example of an algorithm of the collective processing.

FIG. 29 is a flowchart of a collective processing section.

FIG. 30 is a diagram illustrating functional blocks of a wireless communication apparatus according to a fourth embodiment.

FIG. 31 is a flowchart of decoding processing.

FIG. 32 is a diagram illustrating collective processing.

### DESCRIPTION OF EMBODIMENTS

Hereinafter, embodiments will be described in detail with reference to the drawings.

While inventing the embodiments, observations were made regarding a related art. Such observations include the following, for example.

In a wireless communication system of the related art, for example, a codec section in a transmission side performs CRC (Cyclic Redundancy Check) processing on data transmitted from an upper layer and performs bit scrambling processing on the data. The codec section divides the data on which the bit scrambling processing is performed into code blocks (hereinafter referred to as CBs) and performs channel coding processing such as, for example, turbo coding. The codec section performs rate matching processing on the data on which the coding processing is performed, and performs bit collection processing, channel interleaving processing, and constellation rearrangement processing. A modem performs modulation processing on the data on which the constellation rearrangement processing is performed and wirelessly transmits the data to the reception side.

A modem in a reception side performs demodulation processing of a received wireless signal and outputs likelihood data (hereinafter may be simply referred to as “data”). The codec section performs de-constellation rearrangement processing, channel de-interleaving processing, bit de-collection processing, and de-rate matching processing, which are reverse processing of those performed by the codec section in the transmission side. The codec section performs channel decoding on the data on which the de-rate matching processing is performed.

The reception side includes buffers for temporarily storing data on which each processing is performed. For example, the modem stores demodulated data in a buffer. The codec section performs the de-constellation rearrangement processing of the data stored in the buffer and stores the data in another buffer. The codec section performs the channel de-interleaving processing of the data stored in the buffer and stores the data in another buffer. Thereafter, in substantially the same manner, the codec section stores data processed by each processing in a buffer.

As described above, the transmission side processes data for each TRB and transmits the data. Similarly, the reception side processes received data for each TRB. Therefore, for example, the size of the buffers included in the reception side corresponds to the size of TRB.

Here, a data processing apparatus, a wireless apparatus, a decoding apparatus, a data processing method, and a data processing program, which may reduce storage capacity of memory, reduce power consumption, and which may improve throughput of the entire processing, are proposed (for example, see Japanese Unexamined Patent Application Publication No. 2005-333614).

However, there may be a problem that, when the size of data processed at a time in the transmission side increases, the size of the buffers included in the reception side increases. For example, when the size of TRB of data transmitted by the transmission side increases, the size of the buffers between each processing included in the reception side increases.

### First Embodiment

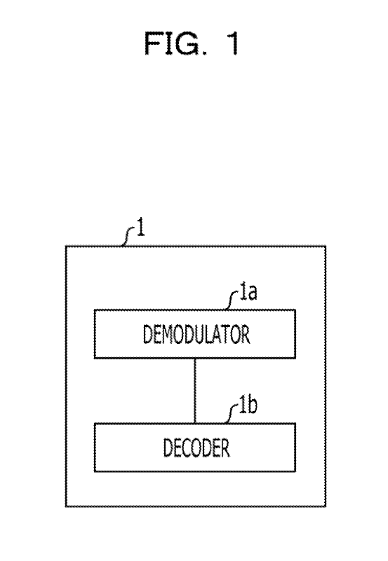

FIG. 1 is a diagram illustrating a wireless communication apparatus according to a first embodiment. As illustrated in FIG. 1, a wireless communication apparatus 1 includes a demodulator 1a and a decoder 1b.

The demodulator 1a demodulates data generated by a transmission side wireless communication apparatus (not illustrated in FIG. 1), which generates the data by performing coding processing for each first block unit and performing channel coding processing included in the coding processing for each second block unit smaller than the first block unit.

The decoder 1b performs decoding processing of the data demodulated by the demodulator 1a for each unit of processing including at least one second block unit.

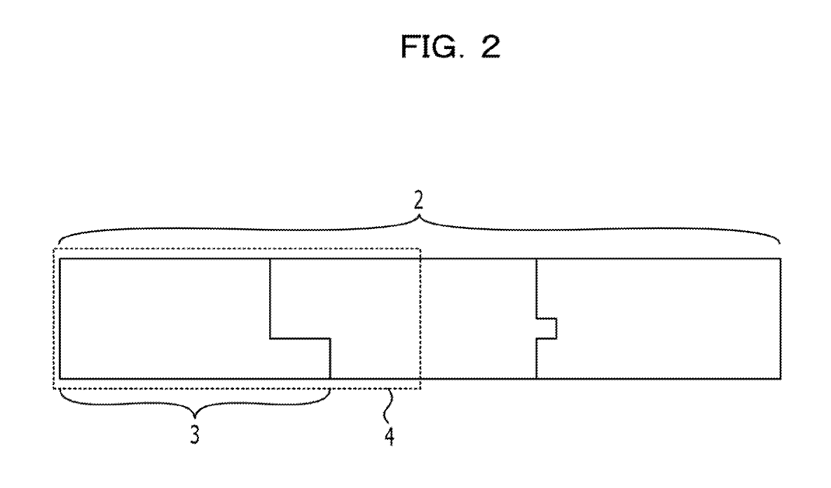

FIG. 2 is a diagram illustrating an operation of the wireless communication apparatus. The transmission side wireless communication apparatus not illustrated in FIG. 1 performs the coding processing for each first block unit. When the transmission side wireless communication apparatus performs the channel coding processing included in the coding processing, the transmission side wireless communication apparatus performs the channel coding processing for each second block unit that is smaller than the first block unit. For example, the first block unit is TRB and the second block unit is CB. The demodulator 1a of the wireless communication unit 1 receives data on which the coding processing is performed from the transmission side wireless communication apparatus and demodulates the data.

The decoder 1b performs the decoding processing of the data demodulated by the demodulator 1a for each unit of processing including at least one second block unit.

For example, FIG. 2 illustrates data demodulated by the demodulator 1a of the wireless communication apparatus 1. A block unit 2 indicates a block unit on which the coding processing is performed by the transmission side wireless communication apparatus. A block unit 3 smaller than the block unit 2 indicates a block unit on which the channel coding processing is performed by the transmission side wireless communication apparatus.

In FIG. 2, the decoder 1b performs the decoding processing on a unit of processing 4 including at least one block unit 3. For example, the decoder 1b performs likelihood generation processing for generating likelihood data of the demodulated data, de-constellation rearrangement processing, channel de-interleaving processing, bit de-collection processing, de-rate matching processing, and channel coding processing on the unit of processing 4. For example, the unit of processing 4 may include two block units 3, however, the unit of processing 4 does not include all the block units 2 forming the block unit 2. Specifically, the unit of processing 4 is smaller than the block unit 2.

In this way, the wireless communication apparatus demodulates the data generated by the transmission side wireless communication apparatus, which generates the data by performing the coding processing for each first block unit and performing the channel coding processing included in the coding processing for each second block unit that is smaller than the first block unit. The wireless communication apparatus performs the decoding processing of the demodulated data for each unit of processing including at least one second block unit. Thereby, the wireless communication apparatus may suppress the size of the buffers.

For example, in the wireless communication apparatus, the size of the buffers used between each processing of the decoder need not be the size of the first block unit, and the size may be a size of a unit of processing including at least one second block unit that is smaller than the first block unit.

### Second Embodiment

Next, a second embodiment will be described in detail with reference to the drawings.

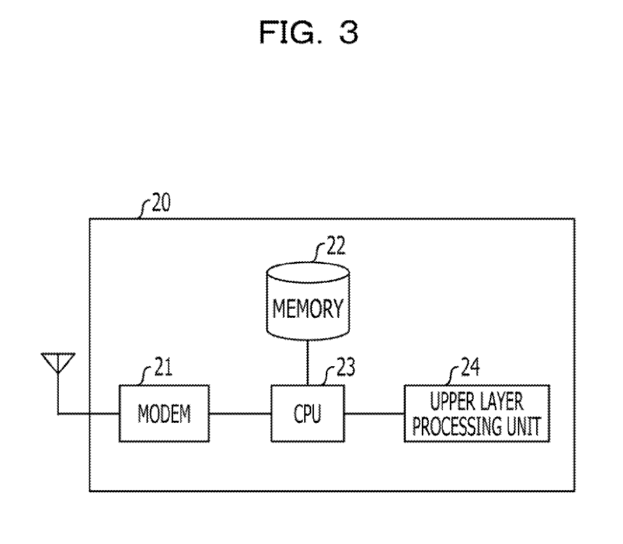

FIG. 3 is a diagram illustrating hardware blocks of a wireless communication apparatus according to the second embodiment. As illustrated in FIG. 3, a wireless communication apparatus 20 includes a modem 21, a memory 22, a CPU (Central Processing Unit) 23, and an upper layer processing unit 24. For example, the wireless communication apparatus 20 is a base station or a mobile phone in a mobile phone system, and performs wireless data communication by HS-DSCH (High Speed Downlink Shard Channel) of HSPA+(High Speed Packet Access). Although FIG. 3 illustrates components of a reception side of the wireless communication apparatus 20, functions of a transmission side may be included.

Data received through an antenna is inputted into the modem 21. The modem 21 performs demodulation processing on the data wirelessly transmitted from the transmission side.

The memory 22 stores a program of decoding processing executed by the CPU 23. The CPU 23 executes the program stored in the memory 22 to perform the decoding processing on the received data.

The upper layer processing unit 24, for example, displays data decoded by the CPU 23 on a display or outputs sound from a speaker.

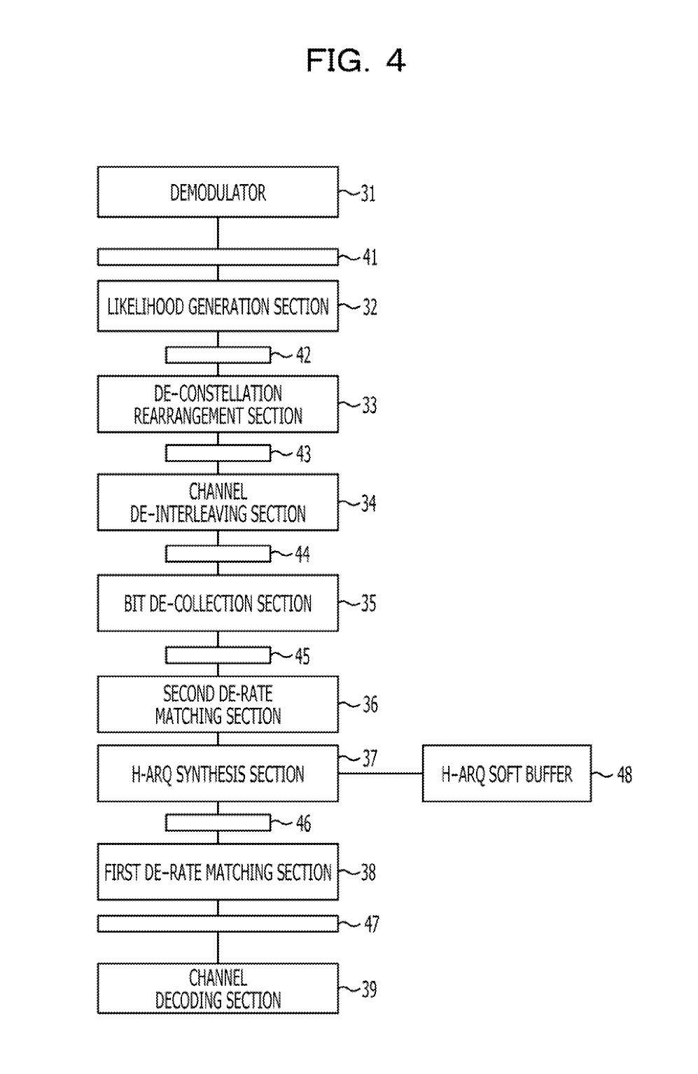

FIG. 4 is a diagram illustrating functional blocks of the wireless communication apparatus. As illustrated in FIG. 4, the wireless communication apparatus 20 includes a demodulator 31, a likelihood generation section 32, a de-constellation rearrangement section 33, a channel de-interleaving section 34, a bit de-collection section 35, a second de-rate matching section 36, an H-ARQ (Hybrid Automatic Repeat reQuest) synthesis section 37, a first de-rate matching section 38, and a channel decoding section 39. The wireless communication apparatus 20 also includes buffers 41 to 47 and an H-ARQ soft buffer 48. The sections 31 to 39 illustrated in FIG. 4 may be referred to as “codec section”. The codec section may include a control section.

The demodulator 31 illustrated in FIG. 4 may be realized by, for example, the modem 21 illustrated in FIG. 3. The demodulator 31 demodulates data generated by the transmission side wireless communication apparatus, which generates the data by performing coding processing for each TRB unit and performing channel coding processing included in the coding processing for each CB unit smaller than the TRB unit.

The sections from the likelihood generation section 32 to the channel decoding section 39 may be realized by, for example, the CPU 23 illustrated in FIG. 3. The channel decoding section 39 may be realized by, for example, a decoder (hardware) not illustrated in FIG. 3.

The buffers 41 to 48 may be realized by, for example, the memory 22 illustrated in FIG. 3. The buffers 41 and 47 have, for example, a size that may store data of at least a TRB unit. The buffers 42 to 46 have, for example, a size that may store data of at least one CB unit.

Hereinafter, the coding processing of the transmission side will be described and a flow of the decoding processing of the wireless communication apparatus 20 will be described. Thereafter, each section in FIG. 4 will be described in detail.

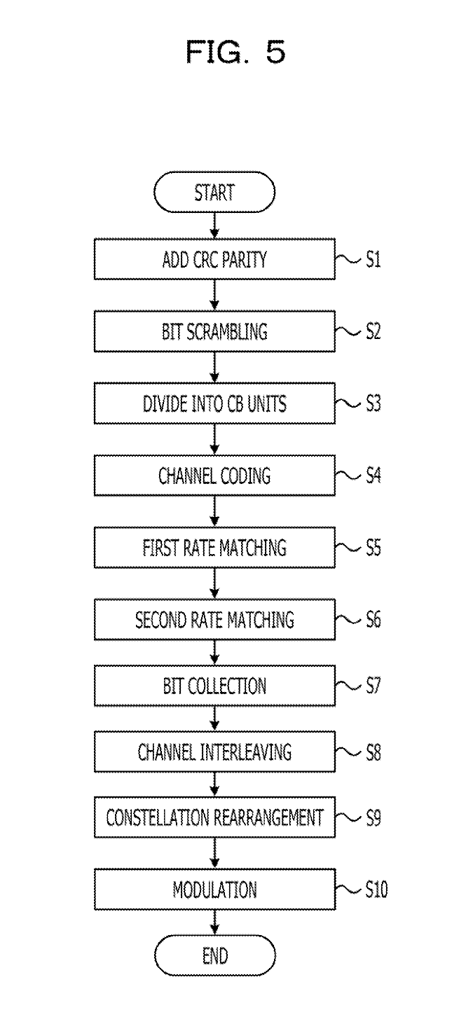

FIG. 5 is a flowchart of the coding processing of the transmission side. The codec section of the transmission side performs the processing described below for each TRB unit. The codec section of the transmission side may be realized by executing a program by a CPU.

[Operation S1] The codec section of the transmission side adds CRC parity bits to data transmitted from an upper layer.

[Operation S2] The codec section performs the bit scrambling processing on the data to which the CRC parity bits are added.

[Operation S3] The codec section divides the data on which the bit scrambling processing is performed into CB units.

[Operation S4] The codec section performs the channel coding processing on data obtained by dividing data of TRB unit into data of CB unit. The channel coding processing is, for example, turbo coding.

[Operation S5] The codec section performs the first rate matching processing on the channel-coded data.

[Operation S6] The codec section performs the second rate matching processing on the data on which the first rate matching processing is performed.

[Operation S7] The codec section performs the bit collection processing on the data on which the second rate matching processing is performed.

[Operation S8] The codec section performs the channel interleaving processing on the data on which the bit collection processing is performed.

[Operation S9] The codec section performs the constellation rearrangement processing on the data on which the channel interleaving processing is performed. The constellation rearrangement processing is applied, for example, only when multilevel modulation is performed.

[Operation S10] The modem performs the modulation processing on the data on which the constellation rearrangement processing is performed.

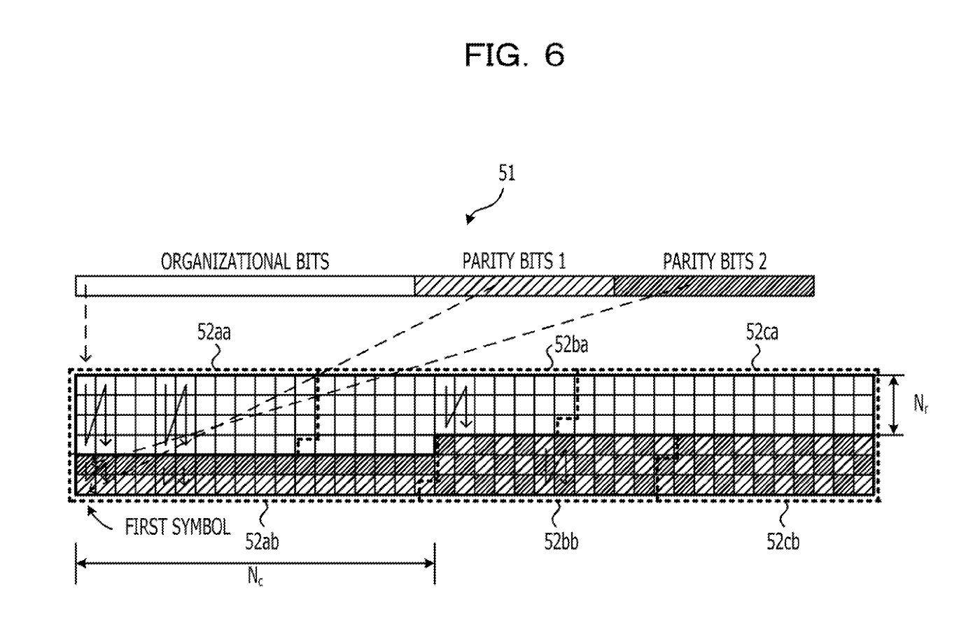

FIG. 6 is a diagram illustrating the bit collection. As described in FIG. 5, data of TRB unit is divided into CBs, and for example, coded by turbo code. The rate matching processing (a combination of the first rate matching processing and the second rate matching processing may be simply referred to as “rate matching processing”) is performed on the turbo-coded data. Data 51 illustrated in FIG. 6 illustrates data obtained by turbo-coding a certain CB data and performing the rate matching processing on the turbo-coded data.

The horizontal direction of a squared diagram illustrated in FIG. 6 indicates an elapse of time, and the vertical axis indicates a bit string (a bit stream mapped in one symbol). A column in the squared diagram in FIG. 6 corresponds to one symbol, and the more right the column is, the later the time is. FIG. 6 illustrates an example of a case in which data is modulated by 64 QAM (Quadrature Amplitude Modulation (m=6 bits)).

In the bit collection, organizational bits and parity bits 1 and 2 of the turbo-coded data 51 on which the rate matching processing is performed are disposed as indicated by arrows in FIG. 6. N_{c} and Nᵣ illustrated in FIG. 6 are obtained according to the specification of 3GPP (3rd Generation Partnership Project).

Frames of dotted line 52aa to 52cb illustrated in FIG. 6 illustrate units of CB1 to CB3. The frames 52aa and 52ab illustrate CB1. The data in the frame 52aa illustrates the organizational bits of CB1. The data in the frame 52ab illustrates the parity bits (the parity bits 1 and 2 may be simply referred to as “parity bits”) of CB1.

The frames 52ba and 52bb illustrate CB2. The data in the frame 52ba illustrates the organizational bits of CB2. The data in the frame 52bb illustrates the parity bits of CB2.

The frames 52ca and 52cb illustrate CB3. The data in the frame 52ca illustrates the organizational bits of CB3. The data in the frame 52cb illustrates the parity bits of CB3.

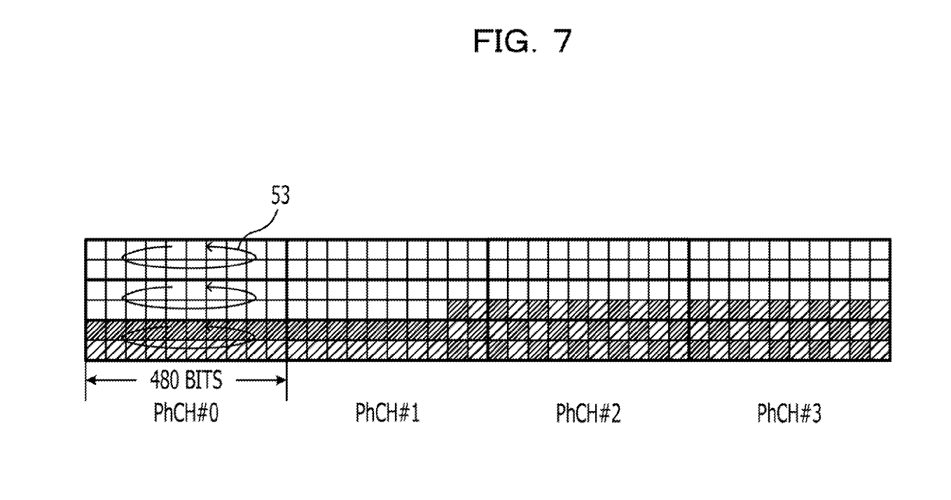

FIG. 7 is a diagram illustrating the channel interleaving. As illustrated in an arrow 53 in FIG. 7, the channel interleaving processing is performed on the data on which the bit collection processing is performed.

The channel interleaving processing is performed for each PhCH (Physical Channel) unit and for each PhCH sub-block unit in which two bits in one symbol are paired. A bold frame illustrated in FIG. 7 illustrates a PhCH sub-block.

The squares that are not shaded in FIG. 7 correspond to the organizational bits described in FIG. 6. The shaded squares correspond to the parity bits 1 and 2 described in FIG. 6.

As described in FIG. 5, the constellation rearrangement processing is performed on the data on which the channel interleaving processing is performed. In the constellation rearrangement processing, positions of bits are changed according to a specified rule for each symbol unit. For example, positions of bits are changed according to a specified rule for each column in FIG. 7.

The data on which the constellation rearrangement processing is performed is modulated by the modem and wirelessly transmitted to the reception side (wireless communication apparatus 20).

A flow of the decoding processing of the wireless communication apparatus 20 will be described.

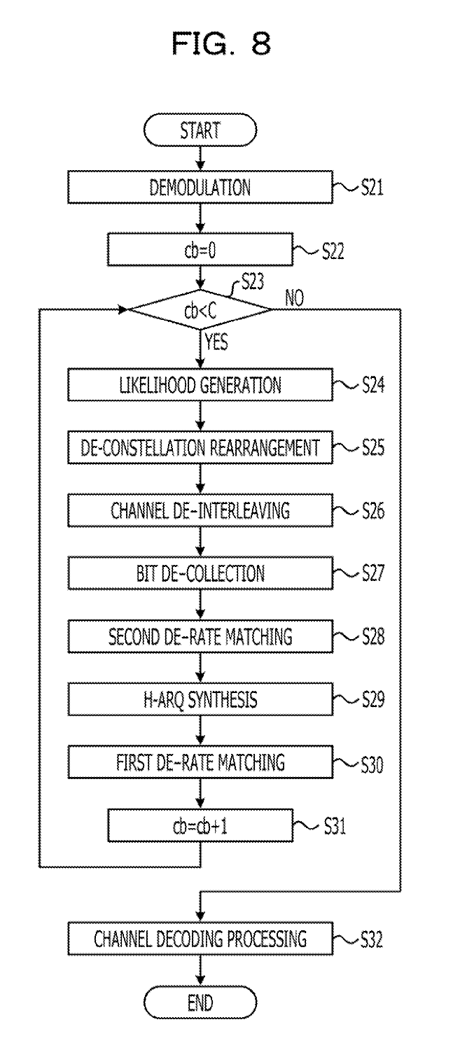

FIG. 8 is a flowchart of the decoding processing of the wireless communication apparatus. The wireless communication apparatus 20 performs the decoding processing in a sequence reverse to that of the coding processing of the transmission side described in FIG. 5.

[Operation S21] The demodulator 31 performs the demodulation processing on the received data. The demodulated data is stored in the buffer 41.

[Operation S22] The control section initializes a variable cb to 0.

[Operation S23] The control section determines whether or not the variable cb is smaller than a variable C. If the variable cb is smaller than the variable C, the control section proceeds to operation S24. If the variable cb is greater than or equal to the variable C, the control section proceeds to operation S32.

The variable C indicates the number of CBs when the TRB is divided into CBs. For example, when the codec section of the transmission side divides the data on which the bit scrambling processing is performed into n CBs and performs the channel coding processing, the value of the variable C is n.

[Operation S24] The likelihood generation section 32 generates likelihood data of the demodulated data stored in the buffer 41. The likelihood generation section 32 stores the generated likelihood data in the buffer 42.

[Operation S25] The de-constellation rearrangement section 33 performs the de-constellation rearrangement processing on the data stored in the buffer 42. The de-constellation rearrangement section 33 stores the data on which the de-constellation rearrangement processing is performed in the buffer 43.

[Operation S26] The channel de-interleaving section 34 performs the channel de-interleaving processing on the data stored in the buffer 43. The channel de-interleaving section 34 stores the data on which the channel de-interleaving processing is performed in the buffer 44.

[Operation S27] The bit de-collection section 35 performs the bit de-collection processing on the data stored in the buffer 44. The bit de-collection section 35 stores the data on which the bit de-collection processing is performed in the buffer 45.

[Operation S28] The second de-rate matching section 36 performs the second de-rate matching processing on the data stored in the buffer 45. The second de-rate matching section 36 outputs the data on which the second de-rate matching processing is performed to the H-ARQ synthesis section 37.

[Operation S29] The H-ARQ synthesis section 37 performs H-ARQ synthesis processing on the data outputted from the second de-rate matching section. When retransmission of the data is performed, the H-ARQ synthesis section 37 performs the H-ARQ synthesis processing by using the H-ARQ soft buffer 48 and stores the result of the H-ARQ synthesis processing in the buffer 46.

[Operation S30] The first de-rate matching section 38 performs the first de-rate matching processing on the data stored in the buffer 46. The first de-rate matching section 38 outputs the data on which the first de-rate matching processing is performed to the buffer 47.

[Operation S31] The control section adds 1 to the variable cb and proceeds to operation S23. That is to say, the control section causes the processing from operation S24 to operation S30 to be performed C times.

[Operation S32] The channel decoding section 39 performs the channel decoding processing on the data stored in the buffer 47. The bit scrambling processing and error detection processing are performed on the data on which the channel decoding processing is performed and the data is outputted to an upper layer.

Each section in FIG. 4 will be described.

### Likelihood Generation Section

Examples of the modulation method include QPSK (Quadrature Phase Shift Keying), 16QAM, and 64QAM. The transmission side maps one complex baseband signal (called “symbol”) to a bit string of the final result of the coding processing (2, 4, and 6 bits respectively for the QPSK, 16QAM, and 64QAM described above).

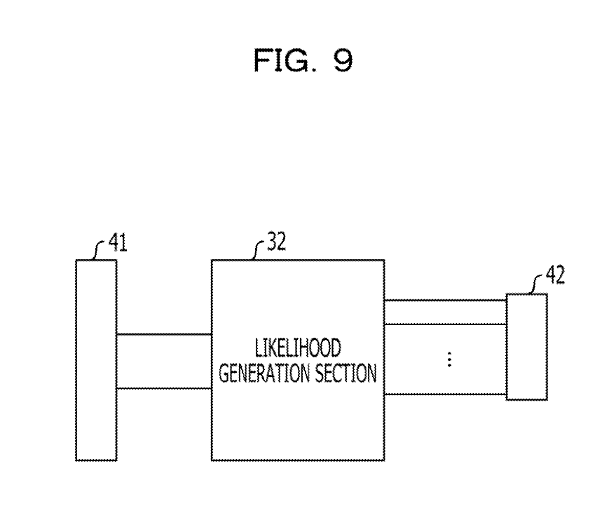

FIG. 9 is a diagram illustrating the likelihood generation. FIG. 9 illustrates the likelihood generation section 32 illustrated in FIG. 4 and buffers 41 and 42.

The modem 21 stores the demodulated data represented as a symbol in the buffer 41 for each TRB unit. The likelihood generation section 32 reads the symbol stored in the buffer 41 for respective I channel and Q channel, and generates likelihood data of the demodulated data by obtaining likelihood of each of bits mapped to respective IQ components of the symbol. The likelihood generation section 32 outputs the generated likelihood data to the buffer 42.

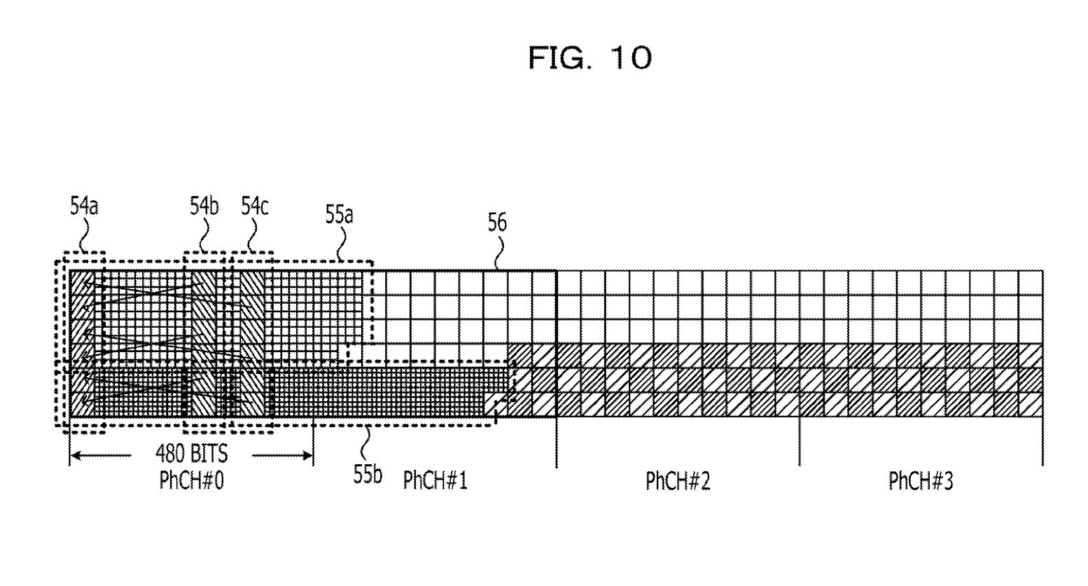

FIG. 10 is a diagram illustrating an example of data outputted from the likelihood generation section. The horizontal direction in FIG. 10 indicates an elapse of time, and the vertical axis indicates bit data outputted from the likelihood generation section 32. In FIG. 10, the more right, the more the time elapses. FIG. 10 illustrates an example of a case in which data is modulated by 64 QAM (m=6 bits). One column in the squared diagram in FIG. 10 corresponds to one symbol.

As described in FIG. 5, the transmission side divides the data on which the bit scrambling processing is performed into CBs and performs the channel coding processing such as the turbo coding. The transmission side performs the rate matching processing, the bit collection processing, the channel interleaving processing, and the constellation rearrangement processing.

Therefore, the arrangement of the bits outputted from the likelihood generation section 32 is different from, for example, the arrangement of the bits illustrated in FIG. 6. For example, the bits in the first symbol illustrated in a frame 54a in FIG. 10 are arranged in frames 54b and 54c and wirelessly transmitted by each processing of the transmission side.

Frames of dotted line 55a and 55b illustrated in FIG. 10 illustrate, for example, CB1. The data in the frame 55a illustrates the organizational bits of CB1. The data in the frame 55b illustrates the parity bits of CB1.

The codec section of the wireless communication apparatus 20 performs processing for each CB unit. Therefore, the buffer 42 has, for example, a size that stores one CB. A frame 56 illustrated in FIG. 10 illustrates the size of the buffer 42. In the example of FIG. 10, the buffer 42 has a size corresponding to two PhCH sub-blocks, and stores data of at least one CB unit.

De-constellation Rearrangement Section

In the transmission side, the arrangement of the bits is changed by the constellation rearrangement for each symbol. Therefore, in the de-constellation rearrangement, displacement processing is performed on the bits stored in the buffer 42 for each symbol to obtain the original data.

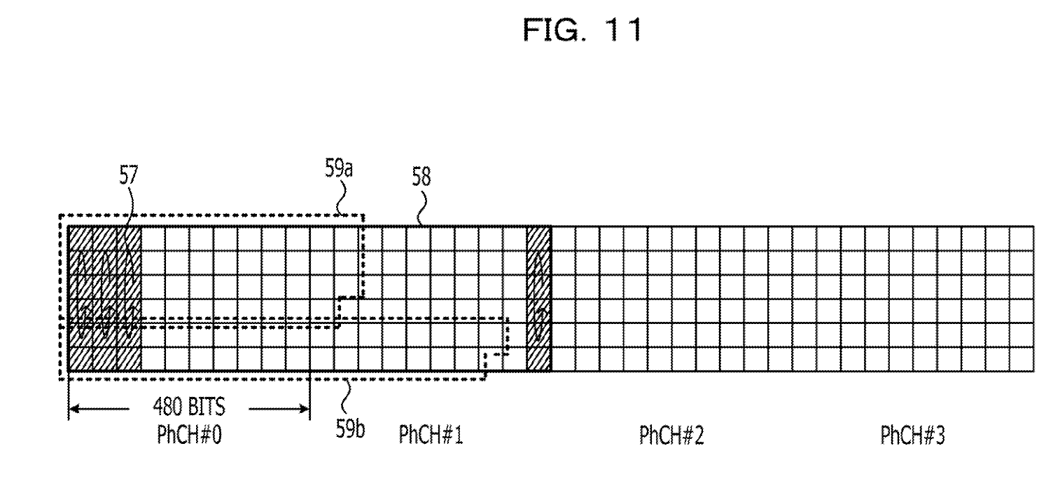

FIG. 11 is a diagram illustrating the de-constellation rearrangement processing. The de-constellation rearrangement section 33 changes the arrangement of the bits stored in the buffer 42 for each symbol. For example, the de-constellation rearrangement section 33 changes the arrangement of the bits for each symbol as illustrated by an arrow 57 in FIG. 11. The de-constellation rearrangement section 33 changes the arrangement of the bits in the opposite direction to the change of the arrangement by the constellation rearrangement of the transmission side.

The de-constellation rearrangement section 33 outputs the bits on which the de-constellation rearrangement processing is performed to the buffer 43. The size of the buffer 43 is substantially the same as that of the buffer 42. A frame 58 illustrated in FIG. 11 indicates the size of the buffer 43. Frames of dotted line 59a and 59b illustrate, for example, CB1. The data in the frame 59a illustrates the organizational bits of CB1. The data in the frame 59b illustrates the parity bits of CB1.

Channel De-interleaving Section

In the transmission side, the channel interleaving processing is performed for each PhCH sub-block unit. Therefore, the channel de-interleaving section 34 performs the channel de-interleaving processing for each PhCH sub-block unit.

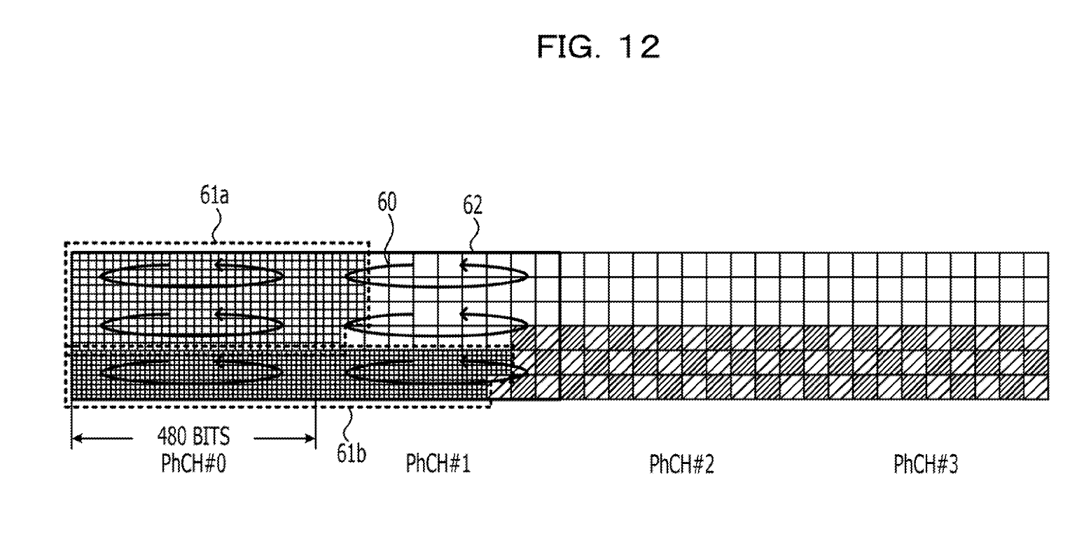

FIG. 12 is a diagram illustrating the channel de-interleaving processing. The channel de-interleaving section 34 performs the channel de-interleaving processing on the bits stored in the buffer 43 for each PhCH sub-block unit. The channel de-interleaving section 34 interleaves the bits in the opposite direction to the channel interleaving processing of the transmission side.

For example, the channel de-interleaving section 34 performs the channel de-interleaving processing for each PhCH sub-block unit as illustrated by an arrow 60 in FIG. 12. Frames of dotted line 61a and 61b illustrated in FIG. 12 illustrate, for example, CB1. The data in the frame 61a illustrates the organizational bits of CB1. The data in the frame 61b illustrates the parity bits of CB1. The squares with oblique lines illustrate the parity bits 1 and 2. The squares without oblique lines illustrate the organizational bits.

The channel de-interleaving section 34 outputs the bits on which the channel de-interleaving processing is performed to the buffer 44. The size of the buffer 44 is substantially the same as that of the buffer 43. A frame 62 illustrated in FIG. 12 illustrates the size of the buffer 44.

As describe above, the channel de-interleaving processing is performed for each PhCH sub-block unit. Therefore, the codec section of the wireless communication apparatus 20 performs the decoding processing, for example, for each PhCH sub-block unit including at least one CB unit. For example, in the example of FIG. 2, the codec section of the wireless communication apparatus 20 performs the decoding processing on two PhCH sub-blocks. It is desired that the codec section performs the decoding processing for each PhCH sub-block unit including one CB unit so as to suppress the buffer size.

Bit De-collection Section

The bit de-collection section 35 calculates a unit of CB on which the bit de-collection processing will be performed in advance in order to perform the bit de-collection processing on the data stored in the buffer 44.

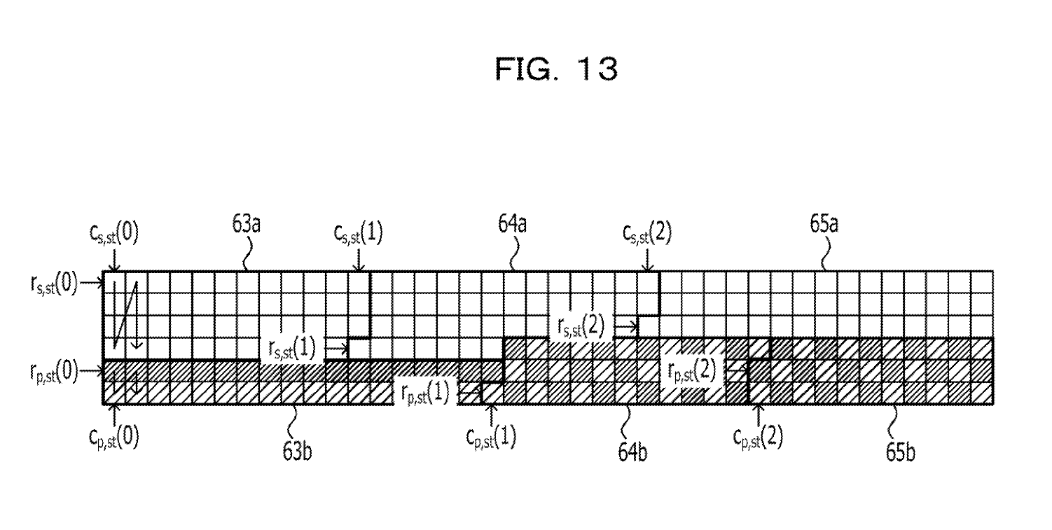

FIG. 13 is a diagram illustrating the bit de-collection processing. Frames 63a and 63b illustrated in FIG. 13 illustrate, for example, CB1. The data in the frame 63a illustrates the organizational bits of CB1. The data in the frame 63b illustrates the parity bits of CB1.

Frames 64a and 64b illustrate, for example, CB2. The data in the frame 64a illustrates the organizational bits of CB2. The data in the frame 64b illustrates the parity bits of CB2.

Frames 65a and 65b illustrate, for example, CB3. The data in the frame 65a illustrates the organizational bits of CB3. The data in the frame 65b illustrates the parity bits of CB3.

Positions c_{s,st}(0) and r_{s,st}(0) illustrated in FIG. 13 indicate the start positions of the bit de-collection in the organizational bits of CB1. Positions c_{p,st}(0) and r_{p,st}(0) indicate the start positions of the bit de-collection in the parity bits of CB1.

Positions c_{s,st}(1) and r_{s,st}(1) indicate the start positions of the bit de-collection in the organizational bits of CB2. Positions c_{p,st}(1) and r_{p,st}(1) indicate the start positions of the bit de-collection in the parity bits of CB2.

Positions c_{s,st}(2) and r_{s,st}(2) indicate the start positions of the bit de-collection in the organizational bits of CB3. Positions c_{p,st}(2) and r_{p,st}(2) indicate the start positions of the bit de-collection in the parity bits of CB3.

It may be said that the start positions of the bit de-collection of CB1 and CB2 respectively indicate the end positions of CB0 and CB1.

For example, the bit de-collection section 35 calculates the start positions of the bit de-collection illustrated in FIG. 13. The bit de-collection section 35 recognizes the positions of the organizational bits and the parity bits of CB1 to CB3 on the basis of the calculated start positions of the bit de-collection, and performs the bit de-collection processing. The bit de-collection section 35 reads the bits of the organizational bits and the parity bits 1, 2 respectively in a unit of CB in substantially the same sequence as the writing sequence of the bit collection.

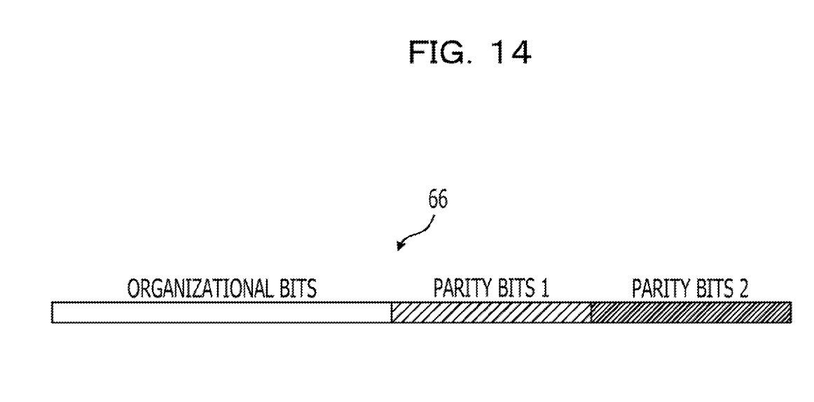

FIG. 14 is a diagram illustrating the data on which the bit de-collection processing is performed. Data 66 illustrated in FIG. 14 illustrates an example of the data obtained by performing the bit de-collection processing on CB1 (frames 63a and 63b) in FIG. 13. The data on which the bit de-collection processing is performed is stored in the buffer 45. The size of the buffer 45 is substantially the same as that of the buffer 44. The size of the buffer 45 may be the size of one CB.

An example of an algorithm for calculating a unit of CB (start position) will be described.

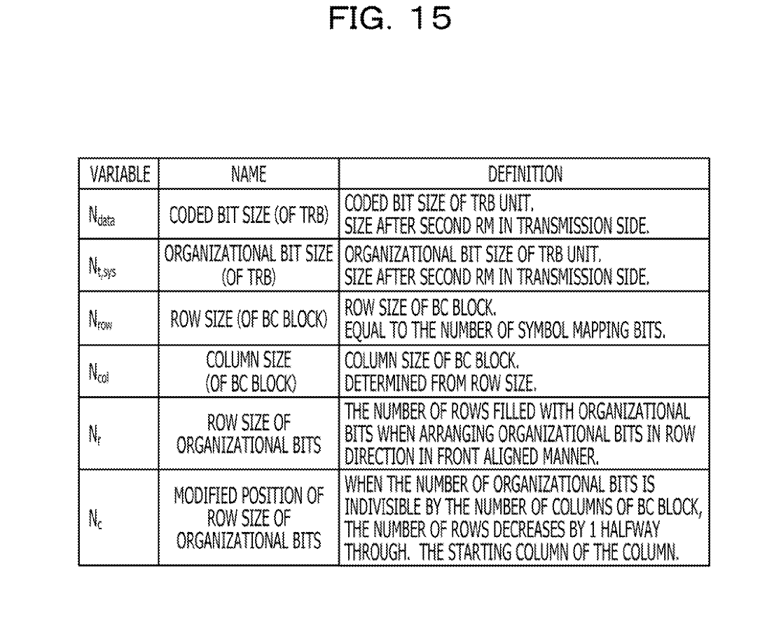

FIG. 15 is a diagram illustrating variable definition for calculating a unit of CB. As illustrated in FIG. 15, a variable N_{data}, a variable N_{t,sys}, a variable N_{row}, a variable N_{col}, a variable Nᵣ, and a variable N_{c} are defined. In FIG. 15, BC indicates the bit collection and RM indicates the rate matching.

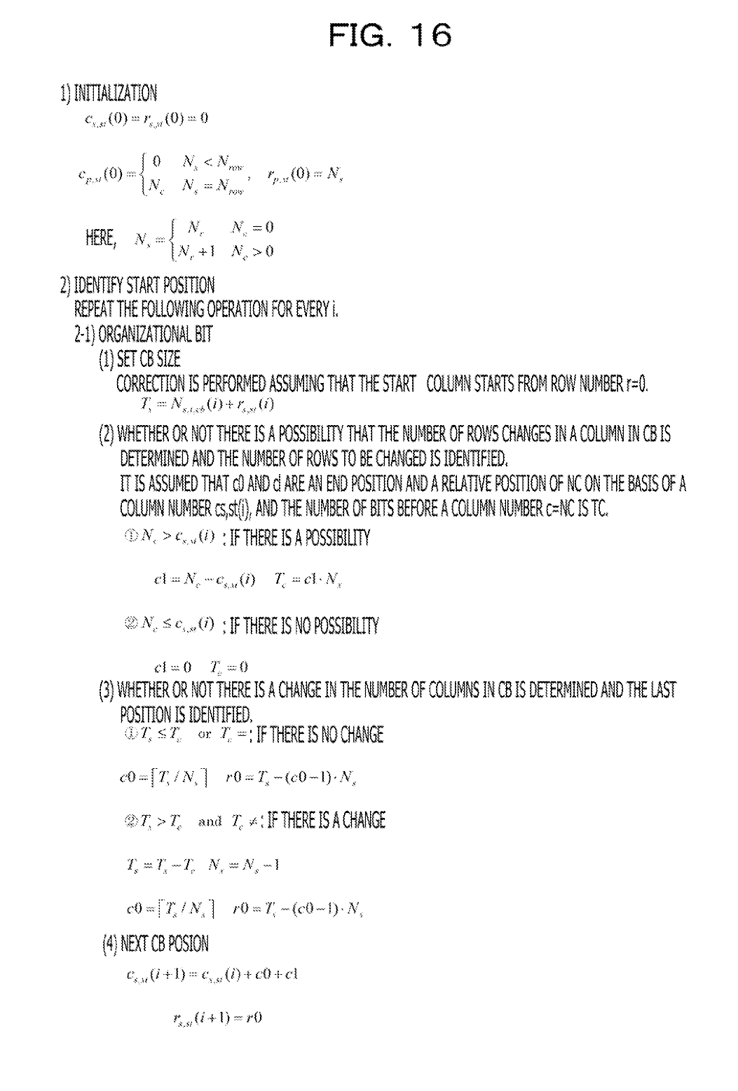

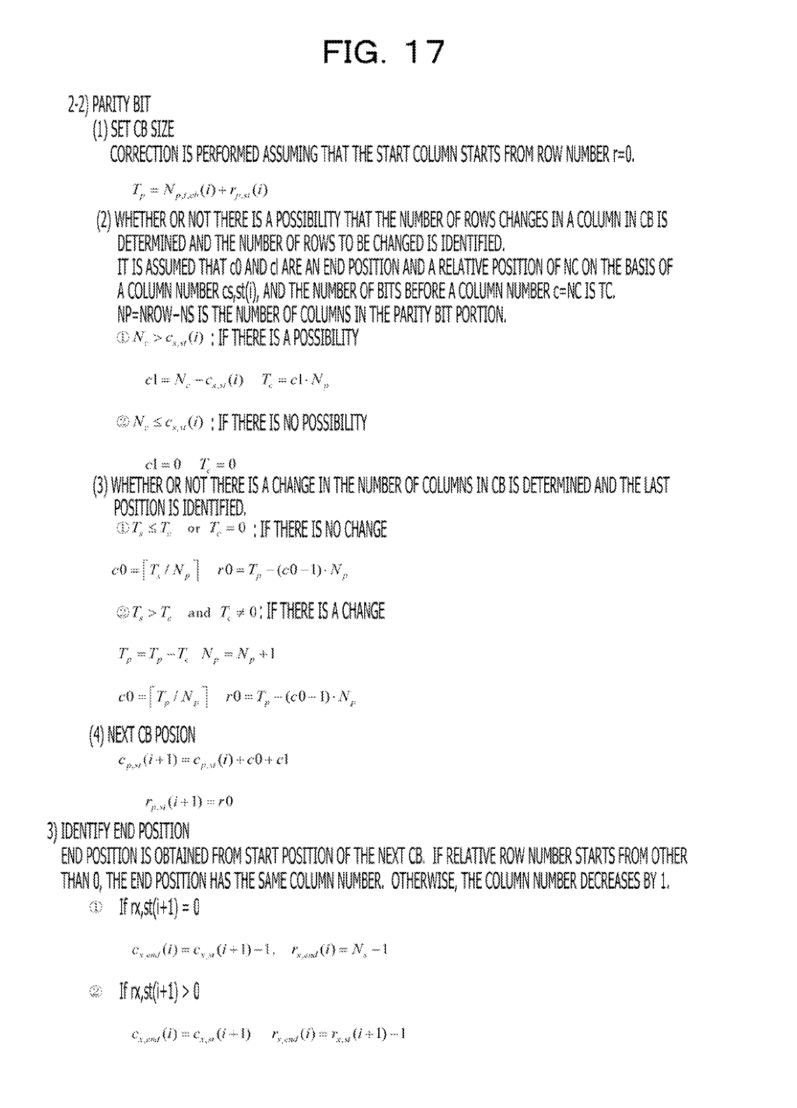

FIGS. 16 and 17 are diagrams illustrating an example of an algorithm for calculating a unit of CB. In FIGS. 16 and 17, c_{x,y}(i) and r_{x,y}(i)(x=s, p:y=st, end) respectively indicate a column number and a row number of the start position and the end position of the ith CB of the organizational bits and the parity bits. The r_{x,y}(i) indicates a relative position in the areas of the organizational bits and the parity bits. The Nₛ is a variable indicating the number of rows of the organizational bits. The Nₛ has a value of Nᵣ or Nᵣ+1 depending on the column. By the algorithm illustrated in FIGS. 16 and 17, the bit de-collection section 35 may calculate, for example, c_{s,st}(0) to c_{s,st}(2) and r_{s,st}(0) to r_{s,st}(2) illustrated in FIG. 13.

Second De-rate Matching Section

The second de-rate matching section 36 performs processing opposite to the second rate matching processing of the transmission side. For example, if puncturing is performed in the transmission side, the second de-rate matching section 36 inserts a bit 0 at a bit position at which the puncturing is performed. If repetition is performed in the transmission side, the second de-rate matching section 36 adds repeated bits and repetition bits and arranges the bits at a bit position before the repetition. In the rate matching processing and the de-rate matching processing standardized by 3GPP, the rate matching processing and the de-rate matching processing are performed by an algorithm using a determination parameter e.

In the transmission side, the second rate matching processing (puncture or repetition) is performed for each TRB unit. Therefore, the wireless communication apparatus 20 which performs the second de-rate matching processing for each CB unit stores the determination parameter e used for the previous second de-rate matching processing and uses the determination parameter e as an initial value of the next second de-rate matching processing.

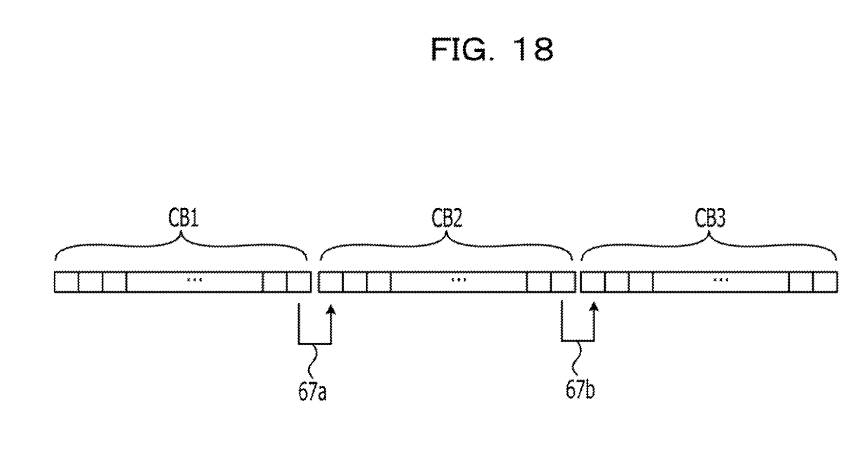

FIG. 18 is a diagram illustrating the second de-rate matching processing. FIG. 18 illustrates data of CB1 to CB3. CB1 to CB3 form one TRB.

As described above, the transmission side performs the second rate matching processing for each TRB unit. Therefore, the second de-rate matching section 36 uses a determination parameter e used for the previous CB de-rate matching processing as an initial value of the next determination parameter e in order to appropriately perform the de-rate matching processing for each CB unit.

For example, as illustrated by an arrow 67a in FIG. 18, the second de-rate matching section 36 uses the last determination parameter e used for the second de-rate matching processing of CB1 as an initial value of the next determination parameter e. Also, as illustrated by an arrow 67b, the second de-rate matching section 36 uses the last determination parameter e used for the second de-rate matching processing of CB2 as an initial value of the next determination parameter e of CB3.

In this way, the determination parameter e is used for the next CB de-rate matching processing, so that the decoding may be performed for each TRB unit.

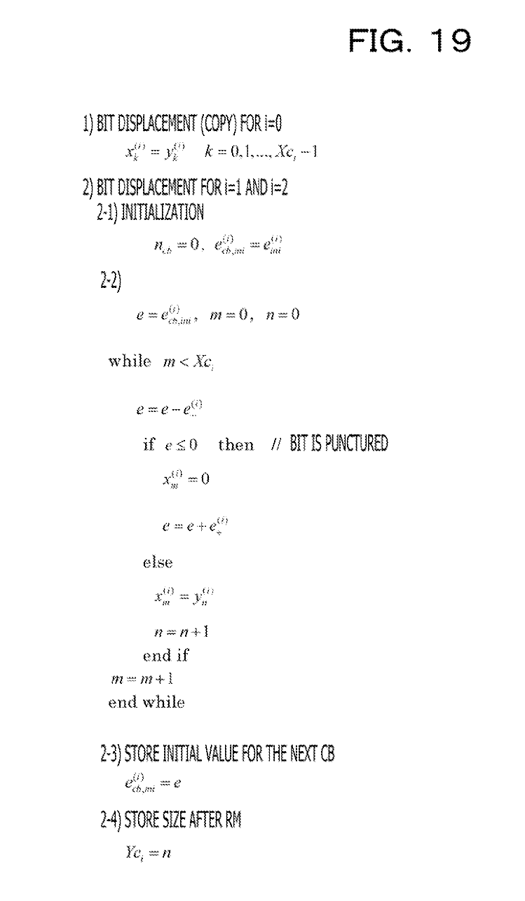

FIG. 19 is a diagram illustrating an example of an algorithm of de-puncture processing of the second de-rate matching processing. Input data for each CB is defined as yₖ⁽ⁱ⁾(I=0, 1, 2, k=0, 1, 2, . . . , Y_{Ci}−1). Output data for each CB is defined as xₖ⁽ⁱ⁾(I=0, 1, 2, k=0, 1, 2, . . . , X_{Ci}−1). Y_{Ci} and X_{Ci} are CB sizes for each series before and after the second de-rate matching. The determination parameters are defined as Xᵢ, eᵢₙᵢ⁽ⁱ⁾, e₊⁽ⁱ⁾, and e₋⁽ⁱ⁾. The initial value parameter for each CB is defined as e_{cb,ini}⁽ⁱ⁾.

The organizational bits are passed through without change. In parity series i=1, 2, a specified eᵢₙᵢ⁽ⁱ⁾ is set as an initial value of e_{cb,ini}⁽ⁱ⁾. In the algorithm illustrated in FIG. 19, when a puncture position is specified, 0 is inserted into the puncture position.

Although the algorithm illustrated in FIG. 19 is substantially the same as the de-puncture processing standardized by 3GPP, as illustrated in 2-2), the determination parameter used for the previous CB is set as the initial value of the determination parameter for the next CB. As illustrated in 2-3), the determination parameter is stored as the initial value for the next CB.

Generally, an input/output size of the second de-rate matching is different for each CB. X_{Ci} is a size of an output result of the first rate matching for each CB, and Y_{Ci} is a size of a result of the second rate matching processing. The X_{Ci} is calculated in advance. The Y_{Ci} may be calculated in advance or a result of the bit de-collection section 35 may be used for the Y_{Ci}. The calculation of the X_{Ci} will be described later.

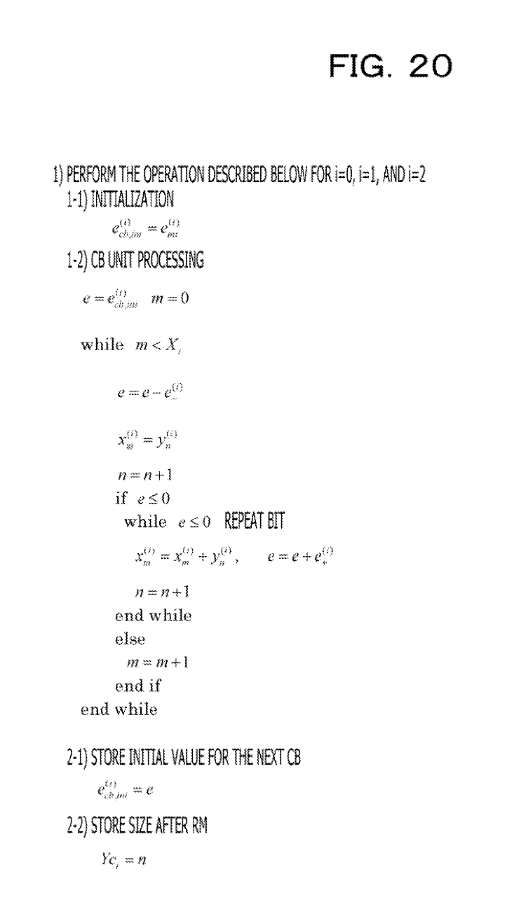

FIG. 20 is a diagram illustrating an example of an algorithm of repetition processing of the second de-rate matching processing. Input data for each CB is defined as yₖ⁽ⁱ⁾(I=0, 1, 2, k=0, 1, 2, . . . , Y_{Ci}−1). Output data for each CB is defined as xₖ⁽ⁱ⁾(I=0, 1, 2, k=0, 1, 2, . . . , X_{Ci}−1). Y_{Ci} and X_{Ci} are CB sizes for each series before and after the second de-rate matching. The determination parameters are defined as Xᵢ, eᵢₙᵢ⁽ⁱ⁾, e₊⁽ⁱ⁾, and e₋⁽ⁱ⁾. The initial value parameter for each CB is defined as e_{cb,ini}⁽ⁱ⁾.

Although the algorithm illustrated in FIG. 20 is substantially the same as the de-repetition processing standardized by 3GPP, as illustrated in 1-2), the determination parameter used for the previous CB is set as the initial value of the determination parameter for the next CB. As illustrated in 2-1), the determination parameter is stored as the initial value for the next CB. In the algorithm illustrated in FIG. 20, the repetition processing is performed for each CB, and while rate matching determination is performed on the bit series i=0, 1, and 2, a repetition bit is accumulatively added to the bit of rate matching source.

Calculation of the size (X_{Ci}) after the first rate matching will be described.

The size after the first rate matching may be calculated by counting how many bits are punctured for the input bits of CB. A calculation example is as follows: After an actual puncturing pattern of CB is obtained (that is, after the first rate matching is performed on CB), the number of bits of the pattern is counted, so that the size after the first rate matching may be obtained.

Another calculation example is as follows: For example, when a decremental value and an incremental value of the determination parameter are e₋ and e₊ respectively and the number of puncturing bits is K, an error variable e_{X} at a certain bit position X has a relationship illustrated by the formula (1) described below.

e_{X}=−e₋·X+e₊·K (1)

From the formula I, K may be obtained as illustrated by the formula (2) described below.

$$K = ⌈ \frac{X \cdot {e}_{+}}{{e}_{-}} ⌉ \qquad ( 2 )$$

Thereby, the second de-rate matching section 36 may calculate the size after the first rate matching in advance by subtracting K from the size of CB before the first rate matching.

The error variable e_{X} is a variable for determining whether or not the bit at the position X is punctured. For example, when e_{X} is smaller than or equal to 0, the bit at the position X is punctured. A pattern of puncture bits may be changed by changing the decremental value e₋, the incremental value e₊, and the initial value of e_{X}.

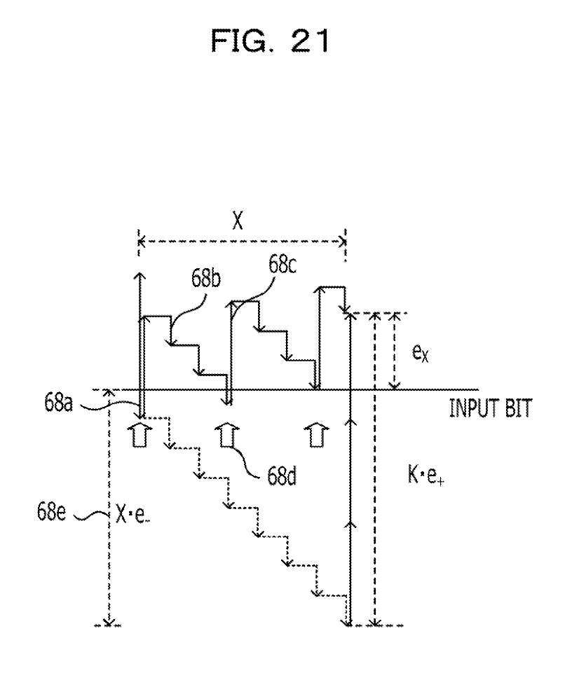

FIG. 21 is a diagram illustrating the size calculation after the first rate matching. The horizontal axis of a graph illustrated in FIG. 21 indicates an input bit on which the first rate matching is performed. The vertical axis indicates the error variable. An arrow 68a indicates the initial value of the error variable e_{X}. An arrow 68b indicates the decremental value e₋. An arrow 68c indicates the incremental value e₊.

The graph in FIG. 21 indicates that the decremental value e₋ is repeatedly subtracted from the error variable e_{X} corresponding to the input bit, and if the determination value e becomes negative when the decremental value e₋ is subtracted m times (m is an integer greater than or equal to 1), mth bit is punctured and the incremental value e₊ is added. An arrow 68d indicates a position of the bit which is punctured.

An arrow 68e indicates the sum of the decremental values of X bits. There is a relationship illustrated by the above formula (1) among X·e₋, K·e₊, and e_{X} illustrated in FIG. 21. Thereby, the second de-rate matching section 36 may calculate the value of K and may calculate the size after the first rate matching in advance.

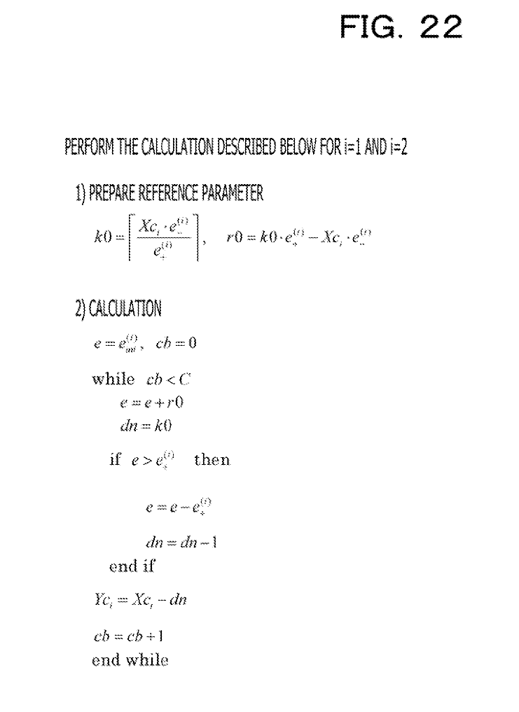

FIG. 22 is a diagram illustrating an example of an algorithm of the size calculation after the first rate matching. In FIG. 22, a variable do corresponds to K. The algorithm of FIG. 22 is performed on the parity bits 1 and 2.

H-ARQ Synthesis Section

The H-ARQ synthesis section 37 performs the H-ARQ synthesis processing on the data outputted from the second de-rate matching section. For example, the H-ARQ synthesis section 37 stores transmitted data in the H-ARQ soft buffer 48. When data is retransmitted, the H-ARQ synthesis section 37 synthesizes the data stored in the H-ARQ soft buffer 48 and the data outputted from the second de-rate matching section 36 together and stores the synthesized data in the buffer 46. The H-ARQ synthesis section 37 adds bits that correspond to the same bit, and if a bit different from any bit that has transmitted previously is transmitted for the first time, the H-ARQ synthesis section 37 superimposes the bit serially without change. The H-ARQ synthesis section 37 stores the synthesized result in the H-ARQ soft buffer 48. The size of the buffer 46 is a size of a CB unit considering the result of the second de-rate matching processing and the result of the H-ARQ synthesis processing.

First De-rate Matching Section

The first de-rate matching section 38 performs the de-puncture processing on the data stored in the buffer 46. The first de-rate matching section 38 performs substantially the same de-puncture processing as that of the second de-rate matching section 36.

The first rate matching processing performed in the transmission side is puncture processing for limiting the transmission data to a size smaller than or equal to the size of the H-ARQ soft buffer. When the size of the bits on which the coding processing is performed is smaller than the size of the H-ARQ soft buffer, the codec section in the transmission side does not performs the first rate matching processing. Therefore, in this case, the first de-rate matching section 38 does not perform the first de-rate matching processing. When the first de-rate matching processing is not performed, the second de-rate matching section 36 does not perform the size calculation after the first rate matching.

The data on which the de-puncture processing is performed by the first de-rate matching section 38 or the data on which the de-puncture processing not is performed are outputted to the buffer 47. The buffer 47 has a size of a TRB unit so that the channel decoding section 39 performs the channel decoding processing for each TRB unit.

In this way, the demodulator 20 demodulates the data generated by the transmission side wireless communication apparatus, which generates the data by performing the coding processing for each TRB unit and performing the channel coding processing included in the coding processing for each CB unit smaller than the TRB unit. The wireless communication apparatus 20 performs the decoding processing of the demodulated data by using the PhCH sub-block that includes at least one CB unit. Thereby, the wireless communication apparatus may suppress the size of the buffers.

When the formats of the channels used in the wireless communication system are the same, if the number of CBs of the format is N, the size of the buffers between each processing may be about 1/N.

When a plurality of formats are used according to a propagation environment in H-ARQ, if there is no specification of a format of retransmission, buffers are prepared according to a format which has a largest size of coded bits when retransmission is performed. The format does not necessarily have the maximum number of CBs, which is N, but may have M CBs (M<N). In this case, the buffer size B_{M} may be smaller than TB_{N} that is necessary to store the entire TRB when the maximum number of CBs is N, so that the buffer size may be smaller accordingly. Specifically, the buffer size becomes B_{M}/TB_{N} times the TB_{N}.

Although the functions of FIG. 4 are formed by the CPU 20 illustrated in FIG. 3, the functions may be formed by a semiconductor chip. In other words, the functions of FIG. 4 may be formed by hardware instead of a program.

### Third Embodiment

Next, a third embodiment will be described in detail with reference to the drawings. In the third embodiment, the likelihood generation processing, the de-constellation rearrangement processing, the channel de-interleaving processing, and the bit de-collection processing are collectively performed.

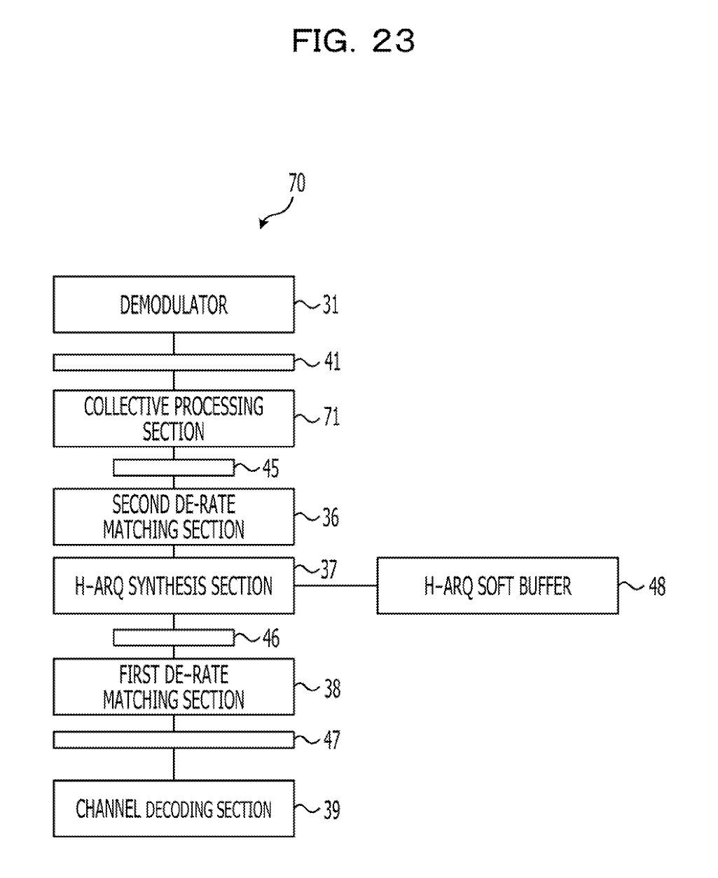

FIG. 23 is a diagram illustrating functional blocks of a wireless communication apparatus according to the third embodiment. As illustrated in FIG. 23, a wireless communication apparatus 70 has a collective processing section 71. In FIG. 23, substantially the same sections as those in FIG. 4 are given the same reference numerals and the description thereof will be omitted. The wireless communication apparatus 70 may be formed by the hardware illustrated in FIG. 3. Or, the wireless communication apparatus 70 may be formed by a semiconductor chip.

The collective processing section 71 collectively performs the likelihood generation processing, the de-constellation rearrangement processing, the channel de-interleaving processing, and the bit de-collection processing. Specifically, the collective processing section 71 outputs data on which the bit de-collection processing is performed without storing data in buffers provided for each processing. Thereby, the buffers 42 to 44 included in the wireless communication apparatus 20 illustrated in FIG. 4 may be removed from the wireless communication apparatus 70.

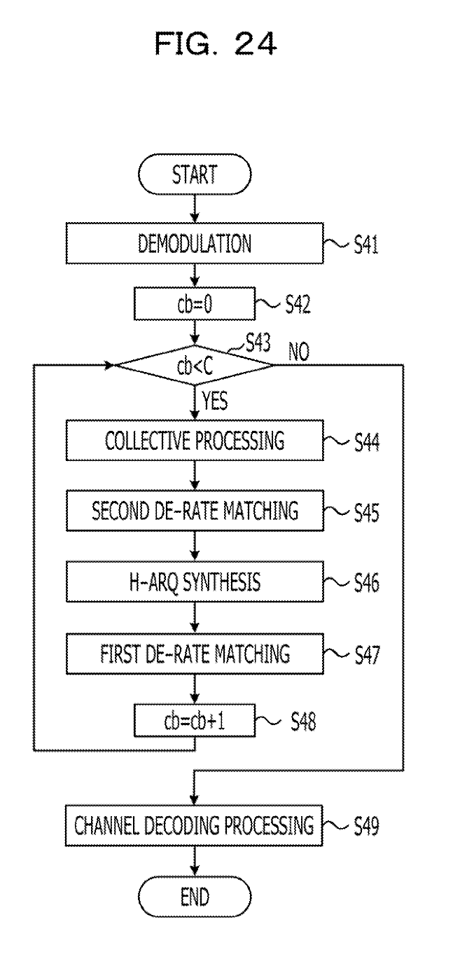

FIG. 24 is a flowchart of the decoding processing.

[Operation S41] The demodulator 31 performs the demodulation processing on the received data. The demodulated data is stored in the buffer 41.

[Operation S42] The control section initializes a variable cb to 0.

[Operation S43] The control section determines whether or not the variable cb is smaller than a variable C. If the variable cb is smaller than the variable C, the control section proceeds to operation S44. If the variable cb is greater than or equal to the variable C, the control section proceeds to operation S49.

The variable C indicates the number of CBs when the TRB is divided into CBs. For example, when the codec section of the transmission side divides the data on which the bit scrambling processing is performed into n CBs and performs the channel coding processing, the value of the variable C is n.

[Operation S44] The collective processing section 71 collectively performs the likelihood generation processing, the de-constellation rearrangement processing, the channel de-interleaving processing, and the bit de-collection processing. The collective processing section 71 stores the collectively processed data in the buffer 45.

Operations S45 to S49 are substantially the same as operations S28 to S32 described in FIG. 8, so that the description thereof will be omitted.

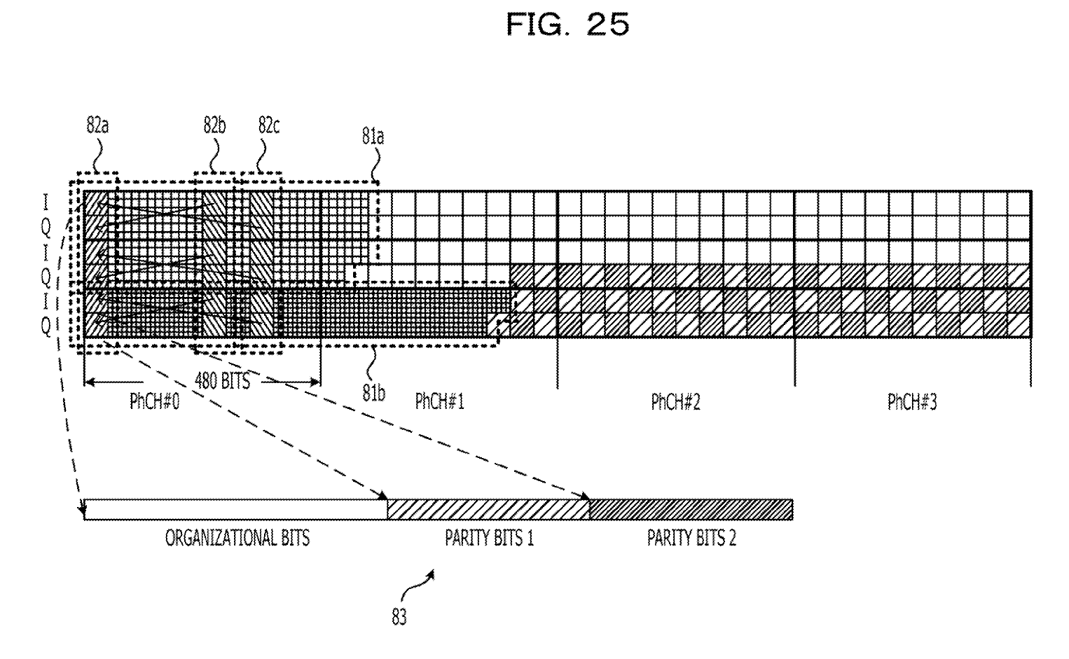

FIG. 25 is a diagram illustrating the collective processing. FIG. 25 illustrates data outputted from the demodulator 31. The horizontal direction in FIG. 25 indicates an elapse of time, and the vertical axis indicates the data outputted from the demodulator 31. In FIG. 25, the more right, the more the time elapses. FIG. 25 illustrates an example of a case in which data is modulated by 64 QAM (m=6 bits). One column in the squared diagram in FIG. 25 corresponds to one symbol.

Frames of dotted line 81a and 81b illustrated in FIG. 25 illustrate, for example, CB1. The data in the frame 81a illustrates the organizational bits of CB1. The data in the frame 81b illustrates the parity bits 1 and 2.

As described above, the transmission side divides the data on which the bit scrambling processing is performed into CBs and performs the channel coding processing such as the turbo coding. The transmission side performs the rate matching processing, the bit collection processing, the channel interleaving processing, and the constellation rearrangement processing.

Therefore, the arrangement of the bits outputted from the demodulator 31 is different from, for example, the arrangement of the bits in the transmission side as illustrated in FIG. 6. For example, the bits in the first symbol illustrated in a frame 82a in FIG. 25 are arranged in frames 82b and 82c and wirelessly transmitted by each processing of the transmission side. Specifically, the data of the first symbol of the transmission side is wirelessly transmitted while being set in positions indicated by the starting points of the arrows illustrated in FIG. 25.

If the reception side may obtain the starting points of the arrows illustrated in FIG. 25, the reception side may recognize at once the bit positions of the first symbol before the interleaving processing in the transmission side even if the reception side does not perform the likelihood generation processing, the de-constellation rearrangement processing, the channel de-interleaving processing, and the bit de-collection processing individually. Specifically, the collective processing section 71 may recognize the symbol position before the interleaving processing in the transmission side from a de-interleaving pattern and a de-constellation rearrangement pattern, and may generate likelihood data of the symbol. When the collective processing section 71 outputs data to the buffer 45 from the first symbol in the order of writing of the bit collection processing, it is possible to obtain, for example, data 83 illustrated in FIG. 25 on which the bit de-collection processing is performed.

Hereinafter, an algorithm of the collective processing of the likelihood generation processing, the de-constellation rearrangement processing, the channel de-interleaving processing, and the bit de-collection processing will be described.

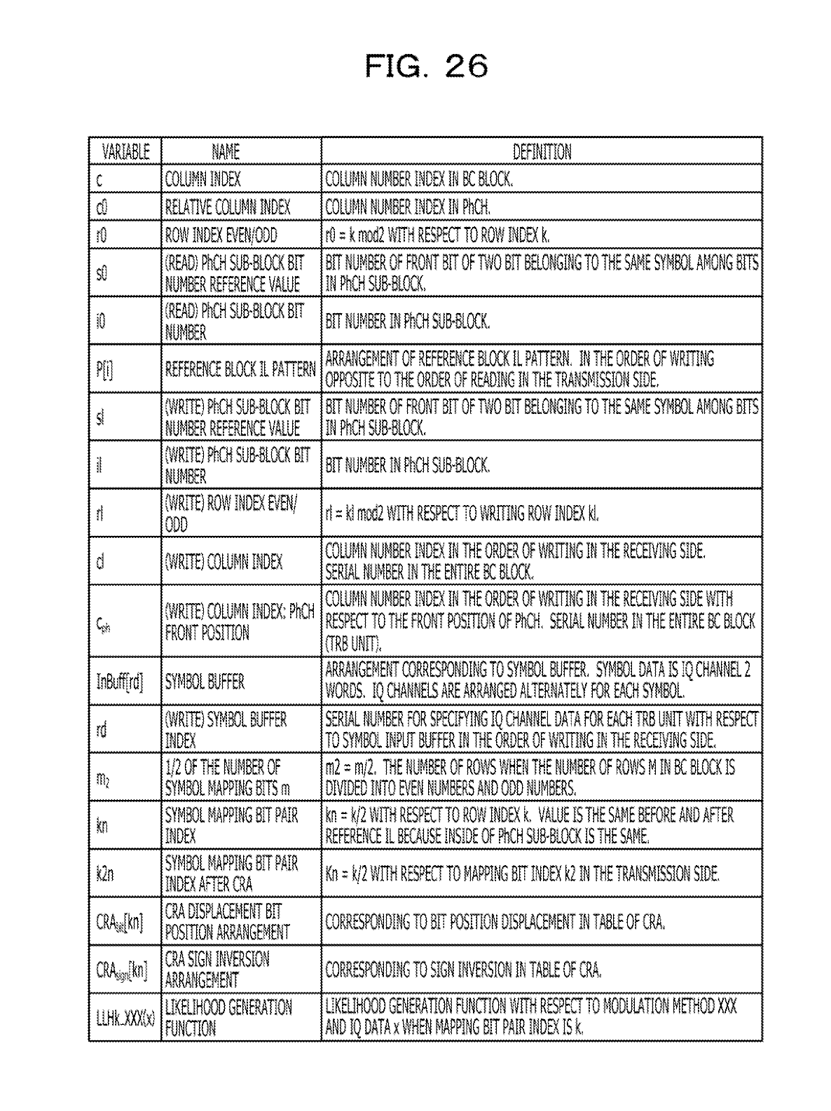

FIG. 26 is a diagram illustrating variable definition for the collective processing. The variables illustrated in FIG. 26 are defined for the algorithm described below. In FIG. 26, IL indicates interleaving, and CRA indicates constellation rearrangement.

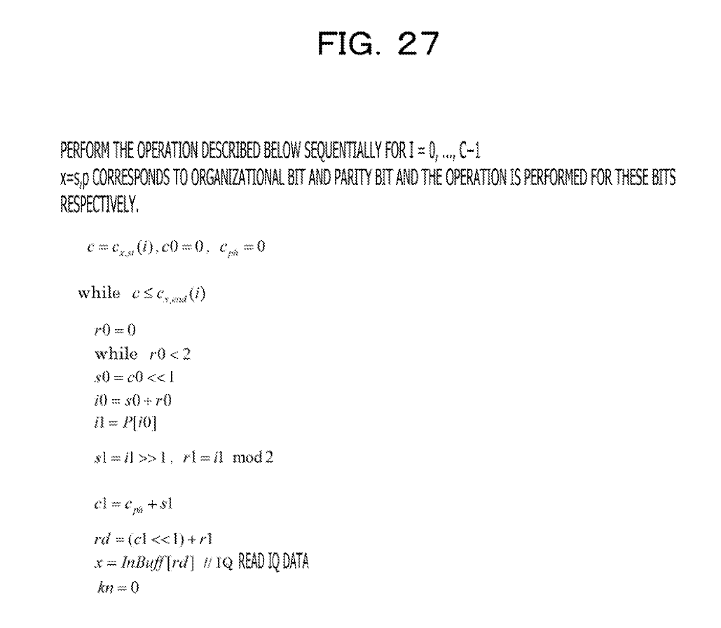

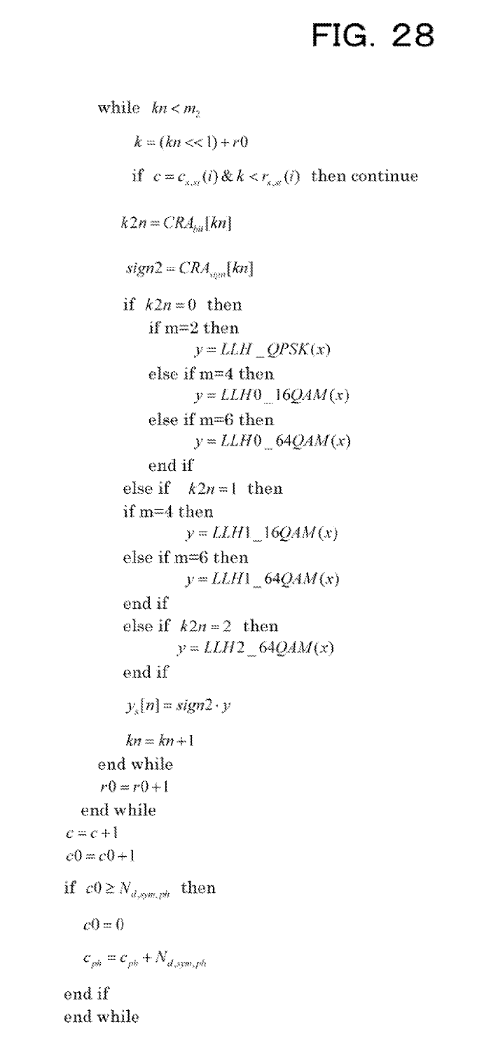

FIGS. 27 and 28 are diagrams illustrating an example of an algorithm of the collective processing. In the algorithm illustrated FIGS. 27 and 28, data is processed for each CB. CB is divided into the organizational bits and the parity bits 1 and 2 and processed in order for each CB. In FIGS. 27 and 28, c_{x,y}(i) and r_{x,y}(i) (x=s,p:y=st, end) respectively indicate a column number and a row number of the start position and the end position of the ith CB of the organizational bits and the parity bits, and may be calculated in advance by, for example, the algorithm illustrated in FIGS. 15 to 17.

The collective processing section 71 identifies IQ components of an input symbol (for example, the frames 82b and 82c in FIG. 25) corresponding to read bits and a mapping position after displacement of the de-constellation rearrangement in a CB unit, and generates likelihood data of the input symbol based on the IQ components and the mapping position.

To perform the above processing, the collective processing section 71 obtains the column number c1 and the row number k1 after the channel interleaving from the column number c0 and the row number k of the read bits, and selects a symbol number s1 and an IQ channel based on the column number c1 and the row number k1. The collective processing section 71 obtains an index k2 of a displacement destination by the constellation rearrangement with respect to the row number k1. When the collective processing section 71 finds the IQ channel and the index k2 for each modulation method, the collective processing section 71 determines a likelihood generation method of the likelihood data.

The collective processing section 71 sequentially performs the above processing by dividing the symbol mapping indexes (row numbers k) with respect to the reading order into even numbers and odd numbers in order to perform the above processing efficiently. In the channel interleaving, pairs of values belong to different processing blocks and the interleaving patterns in a unit of processing are the same in the row number k. Therefore, whether a corresponding row number k1 is even or odd depends on even/odd of the row number k.

The constellation rearrangement is determined depending on an index of 2-bit pair k1n=k½ (a block unit of the channel interleaving processing) regardless of even or odd. Therefore, even/odd of the index k2 of the result of the constellation rearrangement does not change. In other words, a group in which the row number k is even is transferred to a group in which all the row numbers are odd or a group in which all the row numbers are even. Even/odd of the index k2 corresponds to each of the symbol IQ channels. Therefore, processing an even number of the row number k first means that either processing of I or Q channel of the corresponding input symbol is collectively performed. Thereby, the collective processing section 71 may avoid reading symbol data uselessly.

Thereby, the collective processing section 71 reads symbol data with respect to even/odd r0=0, 1 of the row number k at a reading index. The collective processing section 71 sequentially applies a likelihood generation method determined by k2n=k2/2 on IQ data in an order of the index of 2-bit pair kn=k/2. The collective processing section 71 stores the result of the above in the buffer 45 of a CB unit.

First Stage Loop

In the first stage loop, the collective processing section 71 performs processing of the second stage loop for each column in a corresponding CB area in an order of reading in a BC block.

Second Stage Loop

First, the received data will be described. As illustrated in FIG. 25, one column of the BC block corresponds to bits mapped in one symbol. Bits mapped in the I channel and the Q channel of the input symbol are arranged alternately.

However, at a time point when the bits are received, bits included in one column are bits to be respectively displaced from another input symbol (column). The collective processing section 71 identifies the position of the input symbol and the positions in the symbol.

The bits mapped in the symbol are grouped into 2-bit pairs, and the bits belong to a PhCH sub-block. Therefore, a bit position is identified by the index kn(kn=0, . . . , 2m−1) corresponding to a PhCH sub-block number and an index r0 (r0=0, 1) which distinguishes between two bits in a group.

The PhCH sub-block is a unit on which the channel interleaving is performed, and bits belong to the same column are displaced in the PhCH sub-block. Therefore, bits having the same r0 are displaced in substantially the same way.

Therefore, bits having the same r0 in an output symbol (column) are displaced from the same input symbol. Thus, the collective processing section 71 performs the processing described below for each r0.

The collective processing section 71 identifies a buffer index rd of the I channel and the Q channel of a corresponding input symbol for each r0. For example, the collective processing section 71 identifies a column number of the frames 82b and 82c illustrated in FIG. 25.

(1) The collective processing section 71 identifies a column number in the PhCH from a column number in the order of output (column number in the entire BC block).

(2) The collective processing section 71 identifies a reading order index 10 in the PhCH sub-block.

(3) The collective processing section 71 performs reverse displacement by the channel de-interleaving and identifies an index i1 at the time point of transmission.

(4) The collective processing section 71 identifies a column number of the input symbol and an index r1 in 2-bit group from i1.

The collective processing section 71 identifies a data position (rd) of the I channel and the Q channel of the input symbol.

The collective processing section 71 reads data of the I channel and the Q channel by using the identified rd.

Third Stage Loop (Innermost Loop)

The collective processing section 71 sequentially performs processing of bits included in the PhCH sub-block for each r0. The PhCH sub-block is identified by kn.

(1) The collective processing section 71 determines whether or not a corresponding bit in the column is included in the CB area in the BC block. If the bit is not included, the collective processing section 71 does not perform the processing.

(2) The collective processing section 71 performs the de-constellation rearrangement processing to perform the likelihood data generation processing. A sign of data on which the de-constellation rearrangement processing is performed is inverted from the sign of the displacement by the group index of the PhCH sub-block. Therefore, the collective processing section 71 obtains an arrangement table depending only on the index kn of the output symbol in advance and reads a position (k2n) and an inverted sign (sign2) respectively.

(3) The collective processing section 71 generates likelihood data of the input symbol. The collective processing section 71 generates the likelihood data by calling a likelihood processing function different for each k2n because the likelihood generation method varies according to a PhCH sub-block group (k2n) for the input symbol.

(4) The collective processing section 71 multiplies an output result of the likelihood generation function by the sign of the constellation rearrangement.

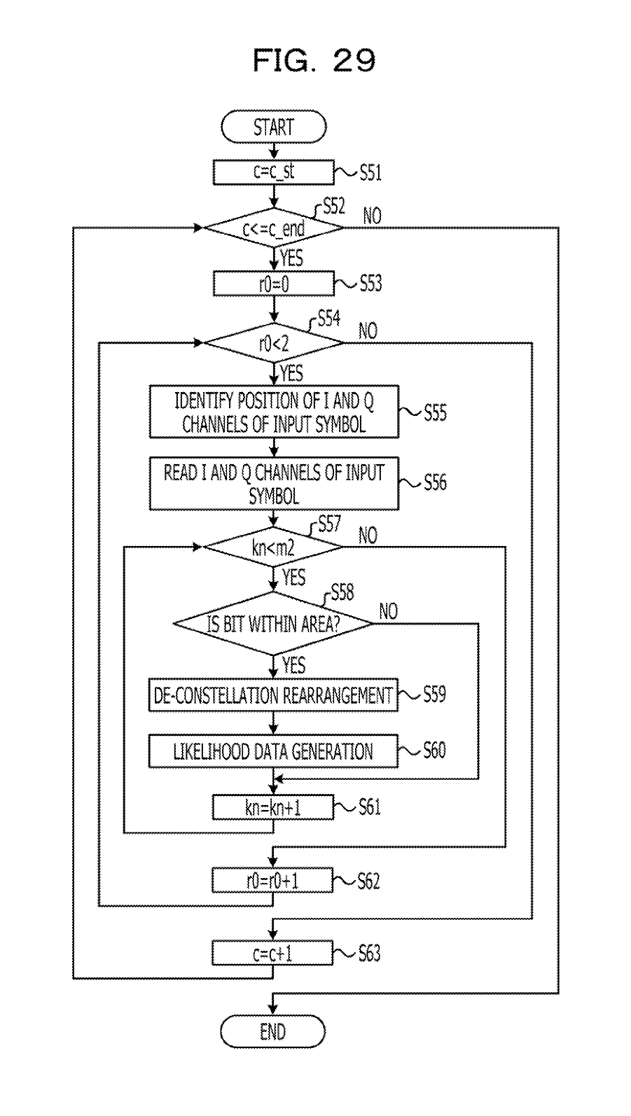

FIG. 29 is a flowchart of the collective processing section. The collective processing section 71 performs the processing described below for each CB.

[Operation S51] The collective processing section 71 substitutes c_st for a variable c. The c_st is a starting column of a CB.

[Operation S52] The collective processing section 71 determines whether or not the variable c is smaller than or equal to c_end. The c_st is an ending column of the CB. If the variable c is smaller than or equal to c_end, the collective processing section 71 proceeds to operation S53. If the variable c is greater than c_end, the collective processing section 71 ends the process.

[Operation S53] The collective processing section 71 substitutes 0 for a variable r0. The variable r0 is an index for distinguishing between two bits in a group.

[Operation S54] The collective processing section 71 determines whether or not the variable r0 is smaller than 2. If the variable r0 is smaller than 2, the collective processing section 71 proceeds to operation S55. If the variable r0 is greater than or equal to 2, the collective processing section 71 proceeds to operation S63.

[Operation S55] The collective processing section 71 identifies a position of the I channel and the Q channel of the input symbol.

[Operation S56] The collective processing section 71 reads the I channel and the Q channel of the input symbol.

[Operation S57] The collective processing section 71 determines whether or not a variable kn is smaller than m2. The variable kn is an index of 2-bit pair. The m2 is ½ of the number of symbol mappings. If the variable kn is smaller than m2, the collective processing section 71 proceeds to operation S58. If the variable kn is greater than or equal to m2, the collective processing section 71 proceeds to operation S62.

[Operation S58] The collective processing section 71 determines whether or not data of the read I and Q channels of the input symbol is within an area of the CB. If the data of the read I and Q channels of the input symbol is within the area of the CB, the collective processing section 71 proceeds to operation S59. If the data of the read I and Q channels of the input symbol is not within the area of the CB, the collective processing section 71 proceeds to operation S61.

[Operation S59] The collective processing section 71 performs the de-constellation rearrangement processing on the data of the read I and Q channels.

[Operation S60] The collective processing section 71 generates likelihood data of the data on which the de-constellation rearrangement processing is performed.

[Operation S61] The collective processing section 71 adds 1 to the variable kn and proceeds to the processing of operation S57.

[Operation S62] The collective processing section 71 adds 1 to the variable r0 and proceeds to the processing of operation S54.

[Operation S63] The collective processing section 71 adds 1 to the variable c and proceeds to the processing of operation S52.

In this way, the wireless communication apparatus 70 collectively performs the likelihood generation processing, the de-constellation rearrangement processing, the channel de-interleaving processing, and the bit de-collection processing. Thereby, in the wireless communication apparatus 70, buffers among the likelihood generation processing, the de-constellation rearrangement processing, the channel de-interleaving processing, and the bit de-collection processing may be removed, so that the buffer size may be suppressed.

### Fourth Embodiment

Next, a fourth embodiment will be described in detail with reference to the drawings. In the fourth embodiment, the collective processing section described in the third embodiment collectively performs the processing further including the second de-rate matching processing.

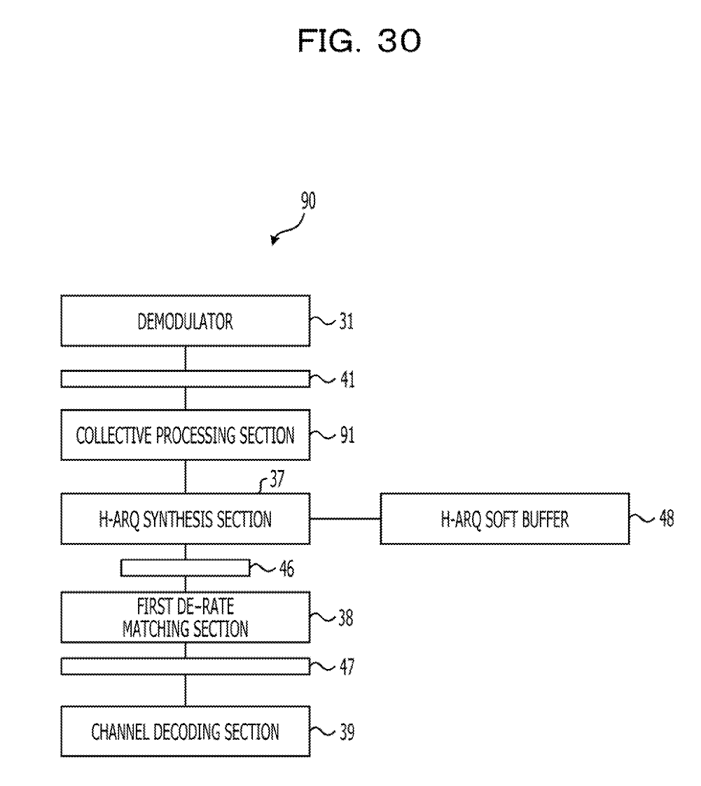

FIG. 30 is a diagram illustrating functional blocks of a wireless communication apparatus according to the fourth embodiment. As illustrated in FIG. 30, a wireless communication apparatus 90 has a collective processing section 91. In FIG. 30, substantially the same sections as those in FIG. 4 are given the same reference numerals and the description thereof will be omitted. The wireless communication apparatus 90 may be formed by the hardware illustrated in FIG. 3. Or, the wireless communication apparatus 70 may be formed by a semiconductor chip.

The collective processing section 91 collectively performs the likelihood generation processing, the de-constellation rearrangement processing, the channel de-interleaving processing, the bit de-collection processing, and the second de-rate matching processing. Specifically, the collective processing section 91 outputs data on which the second de-rate matching processing is performed to the H-ARQ synthesis section 37 without storing data in buffers provided for each processing. Thereby, the buffers 42 to 45 included in the wireless communication apparatus 20 may be removed from the wireless communication apparatus 90.

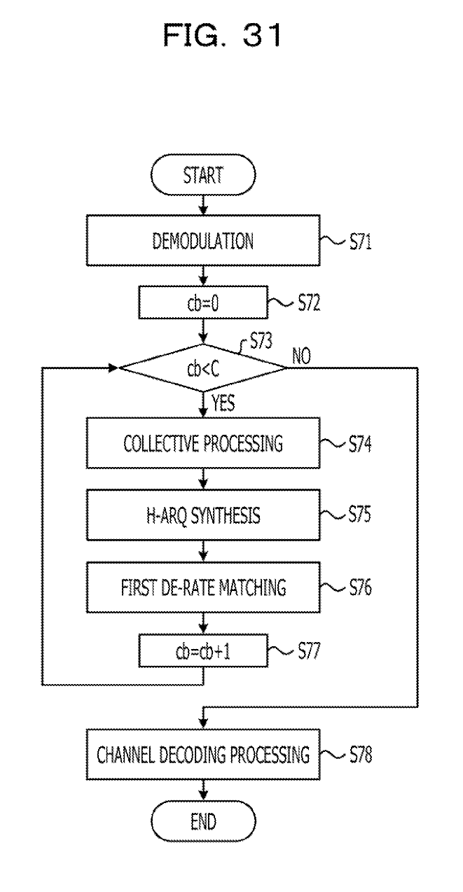

FIG. 31 is a flowchart of the decoding processing.

[Operation S71] The demodulator 31 performs the demodulation processing on the received data. The demodulated data is stored in the buffer 41.

[Operation S72] The control section initializes a variable cb to 0.

[Operation S73] The control section determines whether or not the variable cb is smaller than a variable C. If the variable cb is smaller than the variable C, the control section proceeds to operation S74. If the variable cb is greater than or equal to the variable C, the control section proceeds to operation S78.

The variable C indicates the number of CBs when the TRB is divided into CBs. For example, when the codec section of the transmission side divides the data on which the bit scrambling processing is performed into n CBs and performs the channel coding processing, the value of the variable C is n.

[Operation S74] The collective processing section 91 collectively performs the likelihood generation processing, the de-constellation rearrangement processing, the channel de-interleaving processing, the bit de-collection processing, and the second de-rate matching processing. The collective processing section 91 outputs the collectively processed data to the H-ARQ synthesis section 37.

Operations S75 to S78 are substantially the same as operations S29 to S32 described in FIG. 8, so that the description thereof will be omitted.

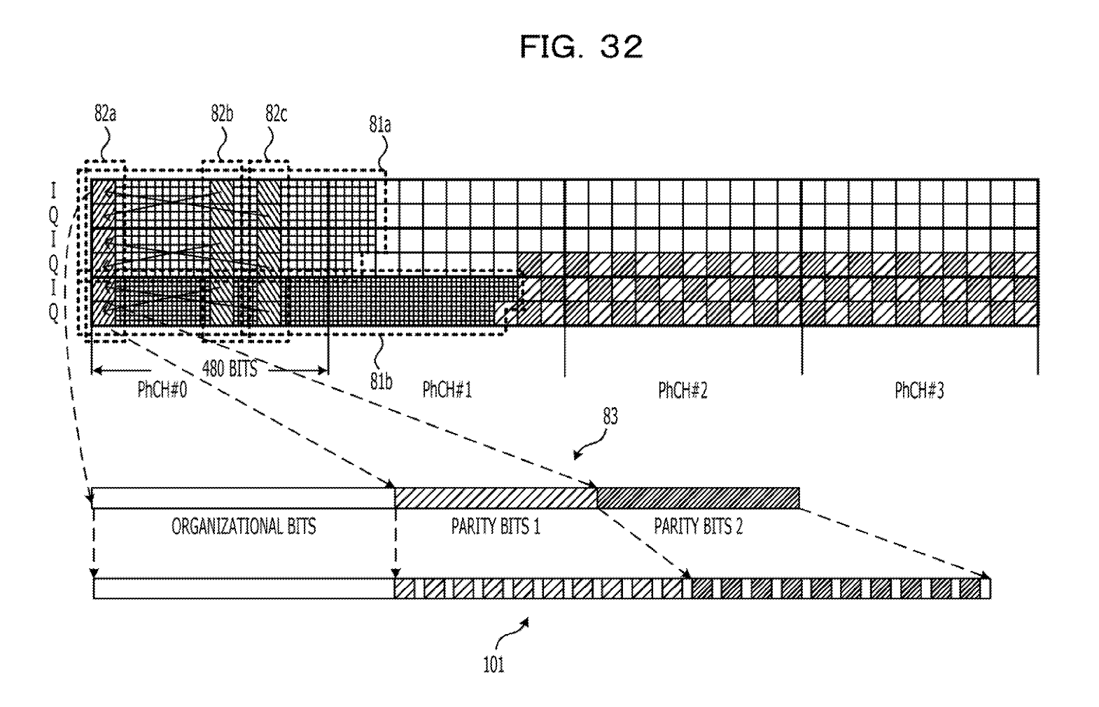

FIG. 32 is a diagram illustrating the collective processing. FIG. 32 illustrates data outputted from the demodulator 31. The horizontal direction in FIG. 32 indicates an elapse of time, and the vertical axis indicates the data outputted from the demodulator 31. In FIG. 32, the more right, the more the time elapses. FIG. 32 illustrates an example of a case in which data is modulated by 64 QAM (m=6 bits). One column of squares in FIG. 32 corresponds to one symbol. In FIG. 32, substantially the same sections as those in FIG. 25 are given the same reference numerals and the description thereof will be omitted.

Data 101 illustrated in FIG. 32 illustrates data obtained by performing the second de-rate matching processing on data 83 on which the bit de-collection processing is performed. As described in the third embodiment, the collective processing section 91 performs the bit de-collection processing as well as the second de-rate matching processing described in the second embodiment, so that the collective processing section 91 outputs the data 101.

In this way, the wireless communication apparatus 90 collectively performs the likelihood generation processing, the de-constellation rearrangement processing, the channel de-interleaving processing, the bit de-collection processing, and the second de-rate matching processing. Thereby, in the wireless communication apparatus 90, buffers among the likelihood generation processing, the de-constellation rearrangement processing, the channel de-interleaving processing, the bit de-collection processing, and the second de-rate matching processing may be removed, so that the buffer size may be suppressed.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A wireless communication apparatus comprising:
a demodulator that demodulates data on which coding processing is performed for each first block unit and channel coding processing included in the coding processing is performed for each second block unit smaller than the first block unit by a transmission side wireless communication apparatus; and
a decoder that performs decoding processing of the demodulated data for each unit of processing including at least one second block unit.

2. The wireless communication apparatus according to claim 1, wherein the unit of processing is a block unit in which interleaving processing is performed on the data.

3. The wireless communication apparatus according to claim 2, wherein, when the decoder performs generation processing for generating likelihood data of the demodulated data, de-constellation rearrangement processing, channel de-interleaving processing, bit de-collection processing, and de-rate matching processing, the decoder outputs result data of each processing to a buffer.

4. The wireless communication apparatus according to claim 2, wherein the decoder performs generation processing for generating likelihood data of the demodulated data, de-constellation rearrangement processing, channel de-interleaving processing, and bit de-collection processing, and outputs result data to a buffer.

5. The wireless communication apparatus according to claim 2, wherein the decoder performs generation processing for generating likelihood data of the demodulated data, de-constellation rearrangement processing, channel de-interleaving processing, bit de-collection processing, and second de-rate matching processing, and outputs result data to a hybrid automatic retransmission synthesis section that performs hybrid automatic retransmission synthesis processing.

6. The wireless communication apparatus according to claim 1, wherein the decoder uses a determination parameter used when performing de-rate matching processing of the second block unit for the next de-rate matching processing of the second block unit.

7. A decoding processing method comprising:
demodulating data on which coding processing is performed for each first block unit and channel coding processing included in the coding processing is performed for each second block unit smaller than the first block unit by a transmission side wireless communication apparatus; and
performing decoding processing on the demodulated data for each unit of processing including at least one second block unit.

8. The decoding processing method according to claim 7, wherein the unit of processing is a block unit in which interleaving processing is performed on the data.

9. The decoding processing method according to claim 8, wherein, the performing decoding processing includes generation processing for generating likelihood data of the demodulated data, de-constellation rearrangement processing, channel de-interleaving processing, bit de-collection processing, de-rate matching processing, and outputting result data of each processing to a buffer.

10. The decoding processing method according to claim 8, wherein, the performing decoding processing includes generation processing for generating likelihood data of the demodulated data, de-constellation rearrangement processing, channel de-interleaving processing, bit de-collection processing, and outputting result data to a buffer.

11. The decoding processing method according to claim 8, wherein, the performing decoding processing includes generation processing for generating likelihood data of the demodulated data, de-constellation rearrangement processing, channel de-interleaving processing, bit de-collection processing, second de-rate matching processing are performed, and outputting result data to hybrid automatic retransmission synthesis processing.

12. The decoding processing method according to claim 7, wherein, in the decoding processing, a determination parameter used when performing de-rate matching processing of the second block unit is used for the next de-rate matching processing of the second block unit.

13. A wireless communication system comprising:
a transmission side wireless communication apparatus including
an encoder that performs coding processing of data for each first block unit and performing channel coding processing included in the coding processing for each second block unit smaller than the first block unit; and
a reception side wireless communication apparatus including
a demodulator that demodulates the coded data, and
a decoder that performs decoding processing of the demodulated data for each unit of processing including at least one second block unit.

14. The wireless communication system according to claim 13, wherein the unit of processing is a block unit in which interleaving processing is performed on the data.

15. The wireless communication system according to claim 14, wherein, when the decoder performs generation processing for generating likelihood data of the demodulated data de-constellation rearrangement processing, channel de-interleaving processing, bit de-collection processing, and de-rate matching processing, the decoder outputs result data of each processing to a buffer.

16. The wireless communication system to claim 14, wherein the decoder performs generation processing for generating likelihood data of the demodulated data, de-constellation rearrangement processing, channel de-interleaving processing, and bit de-collection processing, and outputs result data to a buffer.

17. The wireless communication system according to claim 14, wherein the decoder performs generation processing for generating likelihood data of the demodulated data, de-constellation rearrangement processing, channel de-interleaving processing, bit de-collection processing, and second de-rate matching processing, and outputs result data to a hybrid automatic retransmission synthesis section that performs hybrid automatic retransmission synthesis processing.

18. The wireless communication system according to claim 13, wherein the decoder uses a determination parameter used when performing de-rate matching processing of the second block unit for the next de-rate matching processing of the second block unit.
